(19) United States
(12) Patent Application Publication
(10) Pub. No.: US 2026/0289916 A1
(43) Pub. Date: Sep. 24, 2026

(54) SYSTEMS AND METHODS FOR APPLYING EXTENDED REALITY EFFECTS

(71) Applicant: Adeia Guides Inc., San Jose, CA (US)

(72) Inventors: Ning Xu, Irvine, CA (US); Aldis Sipolins, Somerville, MA (US); Mareeta Mathai, San Jose, CA (US)

(21) Appl. No.: 19/088,322

(22) Filed: Mar. 24, 2025

(51) Int. Cl. G06T 19/00; G06F 3/01; G06V 20/20; G06V 20/40; G06V 20/52; G06V 40/20

(52) U.S. Cl. CPC G06T 19/006; G06F 3/015; G06F 3/016; G06F 3/017; G06V 20/20; G06V 20/41; G06V 20/52; G06V 40/28; G06T 2200/24

(57) ABSTRACT

Systems and methods are provided for applying an extended reality (XR) effect to a portion of a video comprising a portion of a face of a user. A video comprising the user is obtained. A portion of the face of the user is determined to be in contact with a finger of the user based at least in part on the video. Based at least in part on sensor data received from one or more sensors of a device in contact with the user, a force applied by the finger to the portion of the face is determined.

Based at least in part on the determine force, the XR effect is applied to the portion of the video comprising the portion of the face.

### BACKGROUND

This disclosure is directed to systems and methods for applying an extended reality (XR) effect to an environment, such as to a video or image of a user.

### SUMMARY

Traditionally, cosmetic products and beauty tools have been tried on or sampled physically. However, trying on cosmetic products and trying out beauty tools in person can be unhygienic, time-consuming, and inefficient. Demand for virtual makeup try-on applications and digital beauty tools that allow users to experience realistic makeup application in a virtual environment is thus rising. In one approach, systems use augmented reality (AR) technology to provide virtual makeup try-on experiences that allow users to preview cosmetics on a live video or static image. However, such approach focuses on AR or static image overlays without adapting dynamically to specific gestures or tool placements, and lacks the nuanced interactions of physical tools, such as fingers, brushes, and sponges, including variations in pressure, angle, and rolling motions common in real-world makeup application. Further, such approach does not provide users with the ability to accurately control aspects of virtual makeup application such as blending, layering, and shading, and fails to provide dynamic, tactile, fine-tuned feedback to users, thereby reducing the fidelity of virtual makeup applications.

Many users prefer to use a finger, rather than a tool such as a brush or sponge, for applying makeup products such as liquid foundation, eyeshadow, and concealer. Compared with makeup tools, a finger may offer greater precision, and fingers' textured surface make it easier to apply liquids and powders evenly. Additionally, the natural warmth of fingers may make it easier to blend products together on the skin (e.g., concealers, foundations, blushes). Some approaches have explored finger-based tracking techniques. In one approach, systems detect subtle changes in fingertip coloration to track fingertip contact with the face. In another approach, systems allow the user to apply virtual makeup directly on their face using one finger or any similarly shaped object by using computer vision algorithms to detect the touch point. However, these approaches lack the capability to measure applied force or deliver any form of tactile feedback. Without capturing the interplay of finger pressure, skin elasticity, and facial contours, users cannot experience the fine-grained control necessary for realistic makeup application.

There is a need for a system that accurately tracks the finger of a user that is used in an AR environment to apply visual effects in a manner that integrates tactile feedback and gesture sensitivity, allowing users to apply and view makeup in real time, whether through AR or as an overlay on a digital image.

To help address these problems, the present disclosure relates to extended reality (XR) applications that provide a realistic virtual experience of real-world actions in utilizing a tool to interact with an object. Disclosed techniques further relate to simulating the usage of and interaction between various types of tools, applications, and objects or surfaces. Further, this disclosure includes techniques for providing feedback to a user that is responsive to forces applied by the user, and that is unique to combinations of parameters associated with tools, applications, objects, and surfaces. In some embodiments, a combination of tactile and visual feedback may be provided that accurately simulates applying makeup, creating an effective way of teaching precise makeup techniques that generalize to real-world makeup skills.

While techniques are described herein for applying XR feedback to a user in the context of applying virtual makeup, it should be appreciated that the disclosed techniques may be used for any suitable application or purpose. For example, the techniques disclosed herein may be used for a variety of virtual experiences, such as remote training applications, medical applications (e.g., virtual surgery training), other consumer applications (e.g., trying on clothes, shoes, sunglasses, hats, or any other accessories or other clothing), robotics applications, and/or for any other suitable purpose, or any suitable combination thereof.

To further help address these problems, the systems and methods disclosed herein may be configured to apply an XR effect to a user based at least in part on a force applied by a finger of a user to a portion of the face of the user. In some embodiments, a system obtains a video comprising a user. For example, a front-facing camera of a smartphone may capture a video of the face of the user and display the video at a display screen of the smartphone. In some implementations, the system determines, based at least in part on the video, a portion of a face of the user with which a finger of the user is in contact. In some embodiments, employing computer vision and the sensor data of the device in contact with the user (e.g., bracelet-worn sensor data) enables more precise force and gesture recognition, and helps replicate textures, resistance, and behavior of different makeup tools, enhancing the immersive experience.

In some embodiments, the system generates a three-dimensional (3D) model of the face of the user using depth data and/or red, green, and blue (RGB) data. In some implementations, the system generates a 3D model of the finger(s) of the user using the depth data and/or the RGB data. In some embodiments, the system may determine that a finger of the user is in contact with the face of the user by first computing a minimal distance between a fingertip mesh of the 3D model of the finger and a face mesh of the 3D model of the face. In some implementations, the system then determines whether the minimal distance is below a threshold distance. Based at least in part on determining that the minimal distance is below the threshold distance, the system may determine that the finger of the user is in contact with the face of the user.

In some embodiments, the system determines, based at least in part on sensor data received from one or more sensors of a device in contact with the user, a force being applied by the finger to the portion of the face of the user. The device may be a smart watch, a wristband, a wearable, one or more rings, a hand-held controller, any other suitable device, or any suitable combination thereof. The device in contact with the user may comprise an electromyography (EMG) sensor, an accelerometer, a gyroscope, a light sensor, a heart rate sensor, a temperature sensor, any other suitable sensor, or any suitable combination thereof. The system may use a machine learning model to translate wrist (and/or finger or hand and/or any other suitable body part) deformation patterns detected by the device in contact with the user into actionable data. In some embodiments, the machine learning model may continuously adapt to individual user characteristics, thereby improving contact area estimation and deformation accuracy over time.

In some implementations, the system determines the force being applied by the finger to the portion of the face of the user based at least in part on detecting deformations of at least one of the face of the user or the finger of the user. In some embodiments, the system determines the force being applied by the finger to the portion of the face of the user based at least in part on EMG data of the user received from at least one EMG sensor of the device in contact with the user. In some implementations, based at least in part on the determined force, the system applies an XR effect to a portion of the video comprising the portion of the face of the user. In some embodiments, the XR effect may comprises a visual effect. In some embodiments, the XR effect comprises haptic feedback. For example, the XR effect may be an AR cosmetic effect, e.g., blending, layering, shading, etc., that may be adjusted dynamically based on the forces detected by the wristband, providing users with refined control over the virtual makeup process.

In some embodiments, the system provides haptic feedback, via one or more actuators of the device in contact with the user, based at least in part on the determined force. In some implementations, the system receives a selection of a cosmetic tool for the finger of the user to emulate, wherein the haptic feedback simulates a sensation that would be experienced by the selected cosmetic tool. The selected cosmetic tool may be selected from a plurality of cosmetic tools. Each cosmetic tool of a plurality of cosmetic tools may be associated with one or more parameters indicating a manner of applying the visual effect for the respective tool. For example, based on receiving a user selection of an eyeliner brush, the system may cause the finger of the user to emulate the makeup application of an eyeliner brush (e.g., precise, thin lines on the portion of the user where the finger is positioned or in contact with the user's face). The system may provide haptic feedback, via the device in contact with the user, based on the one or more parameters. Such aspects enable the system to help ensure that finger movements and applied pressures mimic real-world makeup techniques, offering a realistic training environment.

In some embodiments, the system applies the XR effect based at least in part on the 3D model of the face and the 3D model of the finger. In some implementations, the system identifies a virtual makeup container in proximity of the user. In some embodiments, the system detects, based at least in part on the video, a gesture made by the user to pick up an amount of virtual makeup from the virtual makeup container. In some implementations, the system applies the XR effect based on the amount of picked up virtual makeup from the virtual makeup container. For example, the system detects that a user has picked up blush from a virtual blush container and then “tapped off” the excess virtual blush from their finger. Tapping off excess product, in real-world application, prevents an excess of product from being applied. Such aspects allow the system to provide a more realistic makeup application experience.

The disclosed techniques may provide a virtual cosmetic application and/or system that allows users to apply digital makeup in a realistic, interactive environment. By integrating computer vision technology, visual cues, and/or force-measuring technology with a device, e.g., a wristband in contact with the user, equipped with sensors, the system tracks the finger's applied force and position relative to the user, allowing the finger to function as a virtual applicator that mimics real-world makeup techniques, responding to various motions like pressure, tilt, and rotation. Using facial landmarks from a stored facial profile, the system aligns virtual effects with specific regions of the user's face, enabling precise and customizable makeup application. This approach supports real-time makeup application on live video feeds or static images (in that the user applies the virtual makeup in a natural way by interacting with their own body, as opposed to performing the input on a touchscreen) and offers adaptable virtual tools that can simulate different applicators, such as brushes and sponges.

### BRIEF DESCRIPTION OF THE DRAWINGS

The present disclosure, in accordance with one or more various embodiments, is described in detail with reference to the following figures. The drawings are provided for purposes of illustration only and merely depict typical or example embodiments. These drawings are provided to facilitate an understanding of the concepts disclosed herein and should not be considered limiting of the breadth, scope, or applicability of these concepts. It should be noted that for clarity and ease of illustration, these drawings are not necessarily made to scale.

FIG. 1 shows an illustrative example of a process for applying an XR effect to a user, in accordance with some embodiments of this disclosure.

FIG. 2A shows an illustrative example of generating tactile feedback to a wrist of a user, in accordance with some embodiments of this disclosure.

FIG. 2B shows an illustrative example of using electromyography (EMG) data to detect user position and muscle activities, in accordance with some embodiments of this disclosure.

FIG. 2C shows an illustrative example of detecting changes in wrist positioning and muscle activities using capacitance, in accordance with some embodiments of this disclosure.

FIG. 3 shows an illustrative example of picking up virtual makeup from a container, in accordance with some embodiments of this disclosure.

FIG. 4 depicts illustrative user equipment devices and systems, in accordance with some embodiments of this disclosure.

FIG. 5 depicts illustrative user equipment devices and systems, in accordance with some embodiments of this disclosure.

FIG. 6 is a flowchart of a detailed illustrative process for applying an XR effect to a user, in accordance with some embodiments of this disclosure.

FIG. 7 is a flowchart of a detailed illustrative process for computing contact area and deformation from sensor input, in accordance with some embodiments of this disclosure.

FIG. 8 is a flowchart of a detailed illustrative process for estimating the force exerted by a fingertip on a user's face, in accordance with some embodiments of this disclosure.

FIG. 9 is a component diagram of a haptic feedback delivery system, in accordance with some embodiments of this disclosure.

FIG. 10 is a flowchart of a detailed illustrative process for applying virtual makeup using a neural network, in accordance with some embodiments of this disclosure.

### DETAILED DESCRIPTION

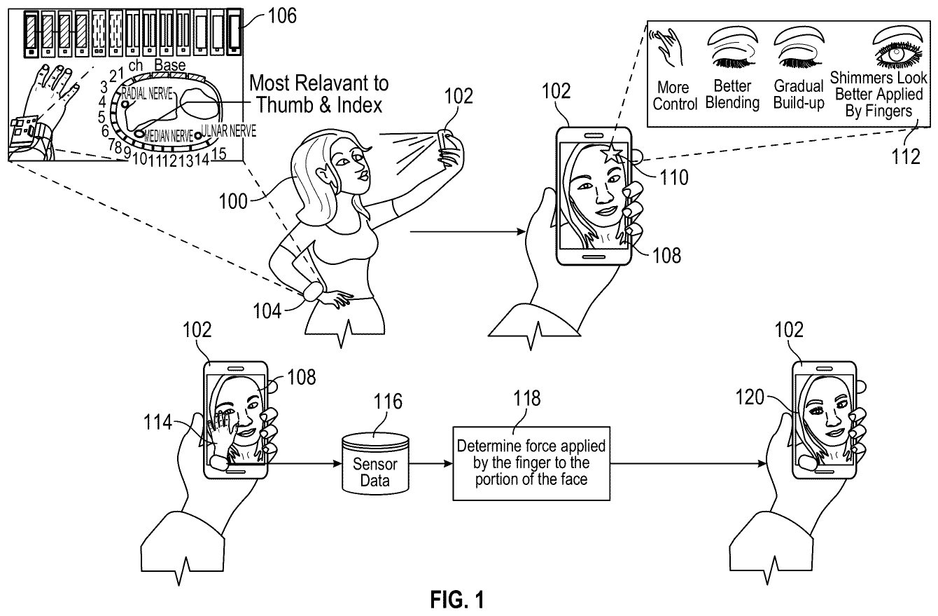

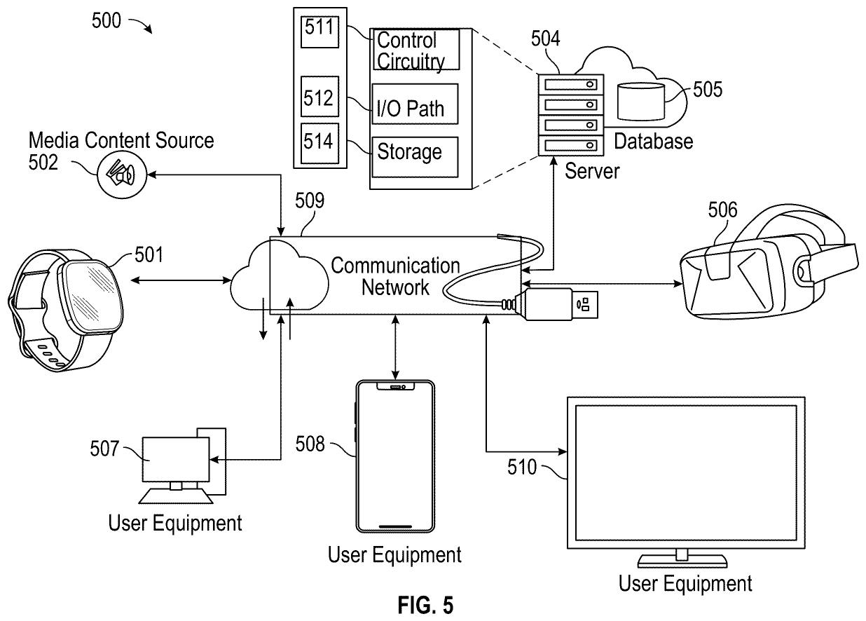

FIG. 1 shows an illustrative example of applying an XR effect to a user, in accordance with some embodiments of this disclosure. FIG. 1 illustrates a system configured to perform various functions described herein. In some embodiments, the system comprises or corresponds to an application that may be executed at least in part on a server (e.g., media content source 502 and/or one or more servers 504 of FIG. 5), a user equipment device (e.g., user device 102 of FIG. 1, devices 506, 507, 508, and/or 510 of FIG. 5, such as, for example, a laptop computer, a personal computer, a desktop computer, a smartphone, a smart television, a smart watch or wearable device, a smart mirror, smart glasses, a stereoscopic display, a wearable camera, XR glasses, XR goggles, an XR HMD, a near-eye display device, etc.), or any other suitable user equipment or computing device, or any combination thereof. The application and/or system may comprise or employ any suitable number of displays, sensors, or devices such as those described herein, or any other suitable software and/or hardware components, or any combination thereof.

XR may be understood as virtual reality (VR), augmented reality (AR), mixed reality (MR) technologies, immersive experiences, and/or interactive experiences, and may provide videos, images, audio, text, haptic feedback, tactile feedback, or any other suitable data or feedback, or any suitable combination thereof. VR systems may project images to generate a three-dimensional environment to fully immerse (e.g., giving the user a sense of being in an environment) or partially immerse (e.g., giving the user the sense of looking at an environment) users in a three-dimensional, computer-generated environment. Such environment may include objects or items that the user can interact with. AR systems may provide a modified version of reality, such as enhanced or supplemental computer-generated images or information overlaid over real-world objects. MR systems may map interactive virtual objects to the real world, e.g., where virtual objects interact with the real world or the real world is otherwise connected to virtual objects. In some embodiments, the environment surrounding user 100 may be a real-world environment, an AR environment (e.g., a real-world environment depicted as having virtual objects overlaid thereon), or a VR environment.

In some embodiments, the system obtains a video (or other imagery, such as, for example, a still photo or live photo or any other suitable imagery) comprising a user (e.g., user 100). The video may comprise the face of user 100 (and/or any other suitable portions of the user such as, for example, an arm, fingernails, toenails). In some embodiments, the system obtains a live image of user 100 from a smart mirror. In some implementations, the system obtains a live video feed from a camera of a user device (e.g., user device 102). In some implementations, the system obtains a pre-captured image of user 100 from a video from storage of user device 102, a video from cloud-based storage associated with user device 102, a photo from storage of user device 102, a photo from cloud-based storage associated with user device 102, any other suitable media storage associated with user device 102, or any suitable combination thereof. In some embodiments, the system obtains a live video feed from third-party cameras, e.g., from within a makeup store. This flexibility may help enable the system to display visual effects applied in real time to a moving image or to a still image for more detailed adjustments. For example, a front-facing camera of user device 102 captures a video of the face of user 100, and the system may cause user device 102 to display the video at a display screen of user device 102 (e.g., display 108).

In some embodiments, the system receives a selection of a cosmetic tool for the finger of user 100 to emulate. For example, the system may receive a selection of an eyeshadow brush for the finger of user 100 to emulate. In some implementations, the system provides a suggestion of a makeup application method. For example, upon receiving a selection of user interface element 110 at display 108, the system causes user device 102 to display diagram 112. Diagram 112, for example, displays a method of applying eyeshadow with the finger itself rather than emulating a tool. In some embodiments, the system may dynamically adapt both haptic (e.g., tactile) and visual feedback to match the selected products, tools, and makeup techniques across a wide variety of makeup techniques.

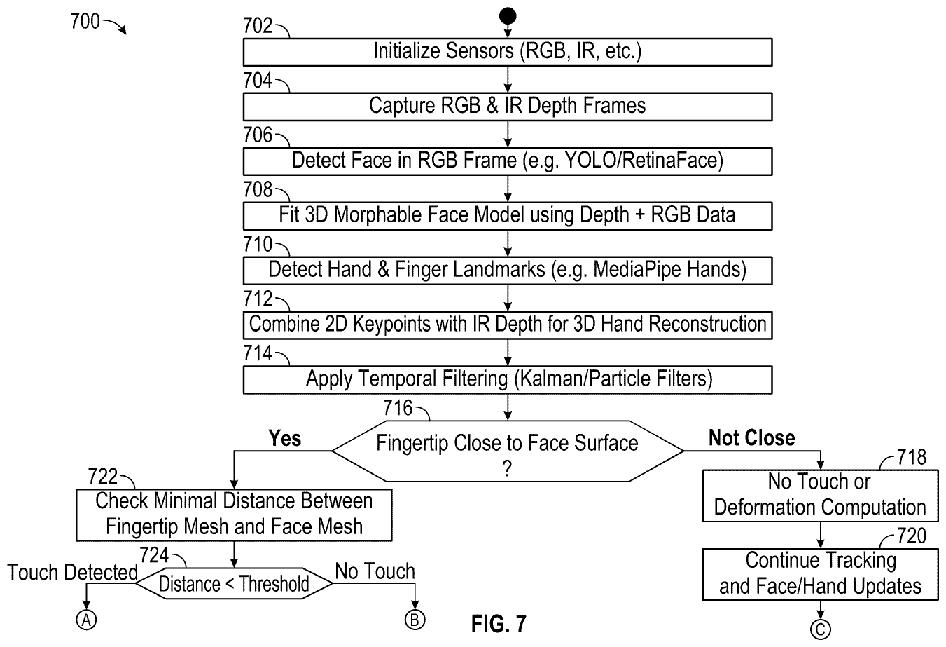

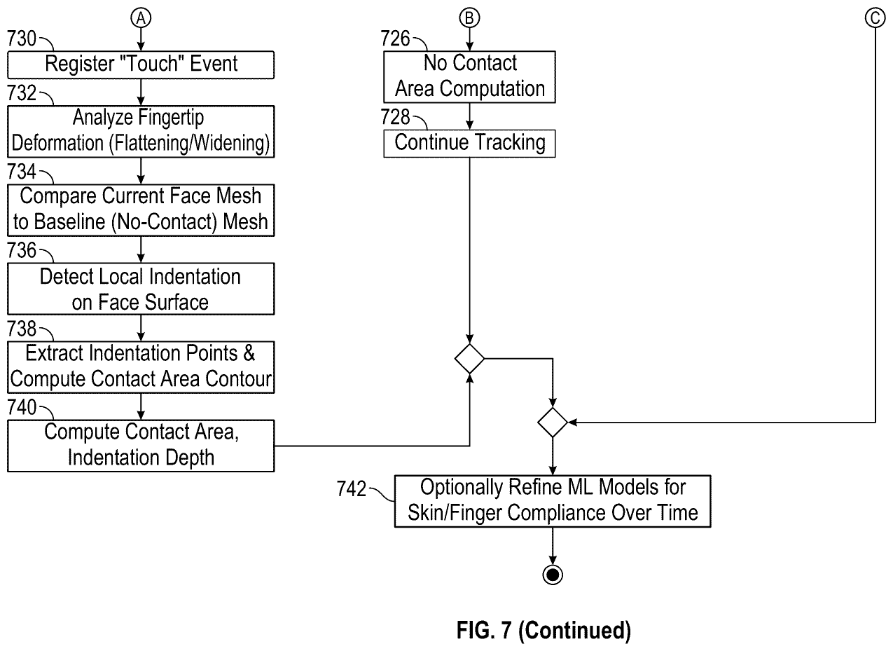

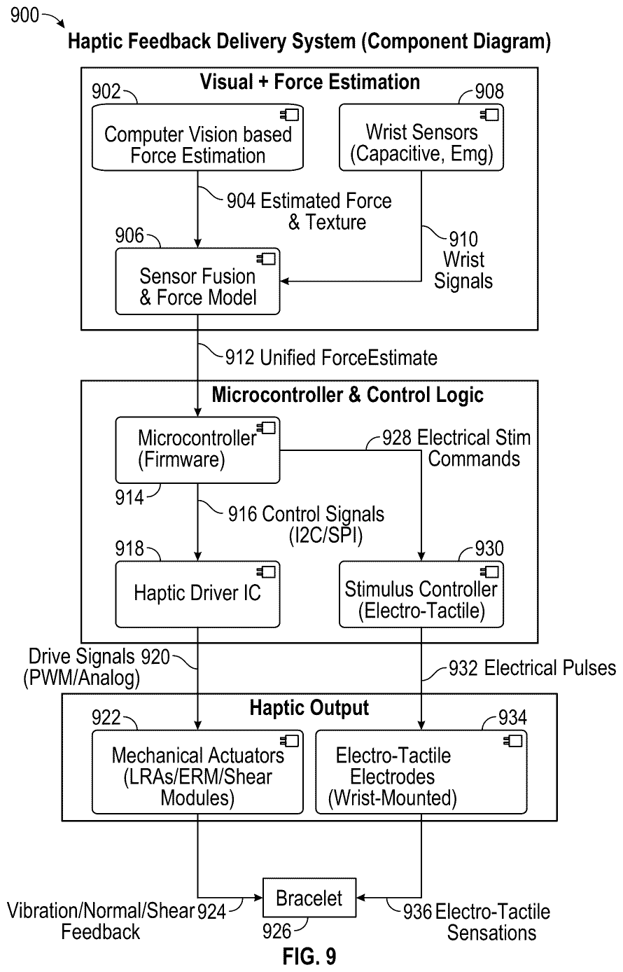

In some implementations, the system determines, based at least in part on the video, a portion of a face of user 100 with which a finger of user 100 is in contact. For example, the system may use one or more computer vision algorithms to determine whether a finger of user 100 (e.g., a finger of hand 114), in one or more frames of the video or other image of the user, is in contact with the face of user 100, as described in detail below in connection with FIGS. 7 and 9. For example, the system may use a computer vision component to analyze location, orientation, direction, and skin topography of the face and fingers to infer the precise motion and pressure being applied. In some embodiments, the system may perform segmentation (e.g., semantic segmentation and/or instance segmentation) on the video or image to identify, localize, distinguish, and/or extract the different objects, and/or different types or classes of objects, or portions thereof. For example, such segmentation techniques may include determining which pixels in the image belong to a particular object. Any suitable number or types of techniques may be used to perform such segmentation, such as, for example: machine learning, computer vision, object recognition, pattern recognition, facial recognition, image processing, image segmentation, edge detection, color pattern recognition, partial linear filtering, regression algorithms, and/or neural network pattern recognition, or any other suitable technique, or any combination thereof. In some embodiments, the system may identify objects by extracting one or more features for a particular object and comparing the extracted features to those stored locally and/or at a database or server storing features of objects and corresponding classifications of known objects.

In some embodiments, the system generates a three-dimensional (3D) model of the face of user 100 using depth data and/or RGB data, as described in more detail below in connection with FIG. 7. The system may receive depth data and/or RGB data from a camera of user device 102. In some implementations, the system generates a 3D model of the finger of user 100 using the depth data and/or the RGB data. In some implementations, the system determines the portion of the face of user 100 with which the finger of user 100 is in contact by first computing a minimal distance between a fingertip mesh of the 3D model of the finger and a face mesh of the 3D model of the face. The system may then determine whether the minimal distance is below a threshold distance. Based at least in part on determining that the minimal distance is below the threshold distance, the system may determine that the finger of user 100 is in contact with the face of user 100. While FIG. 1 describes a finger contacting a face of a user, it should be appreciated that the system may detect that at least one finger is contacting any suitable portion of a user's body (e.g., an arm, a chest, a stomach), another user's body, or an object, and apply a visual effect in relation to such portion of the user's body, another user's body, or object.

In some embodiments, by leveraging a combination of RGB cameras, IR structured light sensors, depth information, and machine learning models, the system can not only track fingertip positions with millimeter-level precision but also determine the nature of the contact between the fingertip and the user's skin. Through detailed geometric and deformation analyses, the system computes the contact area size and shape in real time, enabling a highly realistic simulation of applying makeup products virtually.

In some embodiments, user 100 is in contact with a device (e.g., device 104). Device 104 may be, for example, a smart watch, a wristband, a bracelet, a wearable device worn by user 100, one or more sensors, any other suitable device or component, or any suitable combination thereof. Device 104 may be worn at or near at least one wrist of user 100. Device 104 may comprise an electromyography (EMG) sensor, an accelerometer, a gyroscope, a light sensor, a heart sensor, a temperature sensor, any other suitable sensor, one or more actuators, or any suitable combination thereof. In some embodiments, device 104 sends sensor data detected from its one or more sensors to sensor data database 116. In some embodiments, device 104 sends its sensor data to the system, e.g., device 102 and/or a remote server. Additional sensors incorporated in device 104 may be used to provide a skin health report to analyze the indicators such as skin hydration level, UV exposure, skin temperature, any other suitable skin parameter, or any suitable combination thereof.

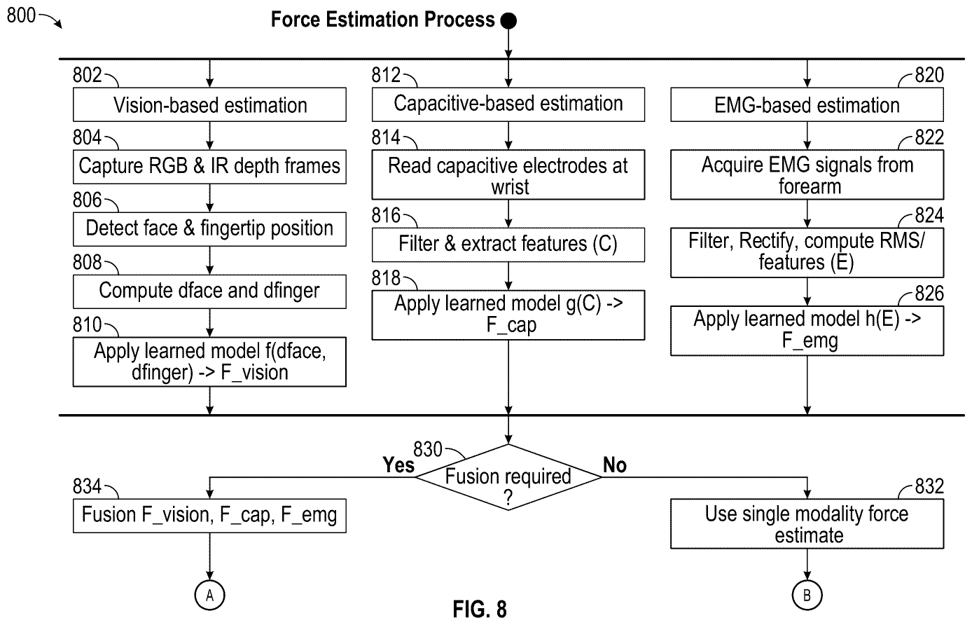

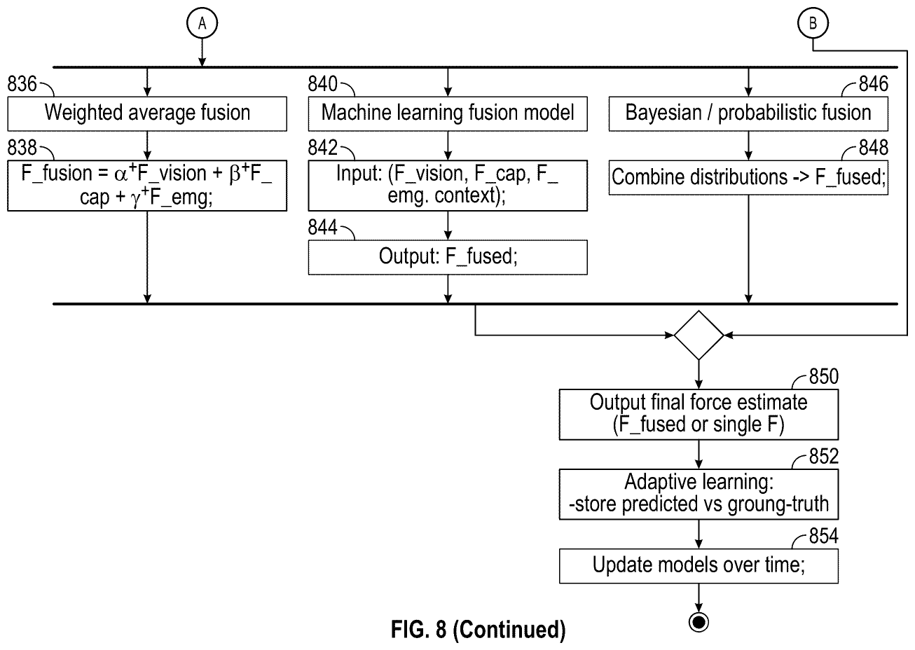

In some implementations, at 118, the system determines, based at least in part on sensor data (e.g., stored at database 116 and/or provided to user device 102), a force being applied or exerted by the finger to the portion of the face of user 100. In some embodiments, the system determines the force being applied by the finger to the portion of the face of user 100 based at least in part on detecting deformations of at least one of the face of user 100 or the finger of the user 100, as described in more detail below in connection with FIGS. 7-8. The system may use a machine learning model to translate wrist, hand, and/or finger deformation patterns detected by the device in contact with the user into actionable data. In some embodiments, the machine learning model may continuously adapt to individual user characteristics, thereby improving contact area estimation and deformation accuracy over time, as described in more detail below in connection with FIGS. 7-8.

In some implementations, based at least in part on the determined force, the system applies an extended reality (XR) effect to a portion of the video comprising the portion of the face of user 100. In some embodiments, the XR effect comprises a visual effect. For example, the system may apply XR visual effect to the portion of the video comprising the eyelids of user 100 (or provide the appearance of lipstick applied to the lips of user 100, or provide the appearance of any other suitable cosmetic to any suitable portion of the image of user 100) and display the effect at display or smart mirror 120. In some embodiments, the system applies the XR effect based at least in part on the 3D model of the face and the 3D model of the finger, as described in more detail below in connection with FIGS. 7-8.

In some embodiments, the XR effect comprises haptic feedback. In some embodiments, the system provides haptic feedback, via one or more actuators of device 104, based at least in part on the determined force. In some implementations, the haptic feedback simulates a sensation that would be experienced by the user when using the selected cosmetic tool. In some embodiments, the system uses visually augmented electro-tactile feedback to deliver haptic feedback to fingers of user 100 via device 104. For example, device 104 may comprise electrodes 106 such as base electrodes and switchable simulation electrodes. The system may apply electrical pulses to the nerves at the wrist of user 100, evoking tactile sensations in the downstream hand or finger. Such sensations may be enhanced when paired with visual depictions of interactions with the affected finger. For example, applying electro-tactile feedback to the index finger while an AR object (e.g., a makeup tool or product) interacted with the finger may cause more convincing haptic feedback than the stimulation alone. In some embodiments, the system may replace the user's fingertip, on the rendering on device 102, with a virtual brush, virtual sponge, virtual applicator or other virtual tool, creating an intuitive and visually immersive interface. The virtual tool may be selected manually by the user or automatically selected by the system.

In some embodiments, the system provides a virtual tutorial to user device 102. For example, the system may use sensor data from sensor data database 116 and computer vision techniques to track real-world tools being used in a real-world application. For example, a tutorial instructor with a wearable device (e.g., device 104) applies real makeup to their own face or to the face of another person (or to an object). The system may analyze and correlate the real-world effects of the makeup application with finger position and muscle activity data and tracked movements of the tools with respect to the instructor. The system may use computer vision techniques, finger position data, and muscle activity data to determine “correct” and “incorrect” positioning data during the real-world demonstration. In some implementations, the system compares the determined positioning data with sensor data from sensor data database 116 when a user is subsequently following the virtual tutorial to produce feedback and guidance.

In some embodiments, user 100 uses a video conferencing application to attend a video conference. The makeup application may be integrated into the video conferencing application and/or integrated into the device running the system described above. User 100 may use the techniques described herein to apply virtual makeup, using techniques described above, before or during the video conference. The other attendees of the video conference may see user 100 with the virtual makeup applied on their respective devices running the video conferencing application, and may also utilize the techniques described herein, e.g., to hold a “makeup watch party.” Such aspects allow a user to appear to be wearing makeup during a video conference. User 100 may also apply different virtual makeup throughout the video conference, allowing user 100 to have flexibility in their virtual appearance without having to physically change their makeup.

In some embodiments, the system may use demographic information to adjust facial skin deformation parameters. Skin tends to lose elasticity with age, meaning that older skin may push back less against a finger applying makeup. As a result, the same finger using the same amount of force may apply makeup differently on older and younger faces. The system may apply the XR effect based on a modified skin elasticity parameter based on demographic factors such as a user's age and weight, as well as other factors such as, for example, cumulative sun exposure and history of smoking cigarettes.

In some implementations, the system may enable user 100 to measure their skin elasticity. Existing methods (for example, pinching or snapping the skin and observing how long the skin takes to return to its original shape) are manual, subjective, and error-prone. For example, user 100, while wearing device 104, may be prompted by the system to place their finger on a specific region of their face and slowly apply pressure. The system may calculate an elasticity parameter by comparing the detected force being applied by the finger with the displacement of the face surface (e.g., how far the finger has pressed into the face skin). The system may track how finger force increases as it presses into face skin until it begins pressing against more dense subsurface material (e.g., bones, teeth). The system may analyze the resulting finger depth vs. finger force curve to determine a skin elasticity parameter for the specific facial region, which may be combined with skin elasticity parameters from other facial regions to create a single composite score.

The system may also use geographical information of user 100 to determine factors such as, for example, humidity and heat/sun exposure. For example, light makeup, oil-free sunscreen and lightweight, water-based moisturizer may be preferred in high humidity locations. The system may retrieve geographic data of user 100 stored in a user profile and provide suggestions of products to user 100. Other factors, such as the undertone of user 100, may also be considered while developing a personal profile for user 100. In some embodiments, the system may suggest a matching color palette while applying makeup such as lipstick, eyeshadow, and blush to complement the accessories or outfit of user 100. The system may capture the user's current outfit, and/or user 100 may enter the desired color information. Based on the time of day, alongside suggesting makeup products, the system may be trained to suggest appropriate accessories to complement the whole look. These products may also be linked to an e-commerce website to allow user 100 to purchase the specified items.

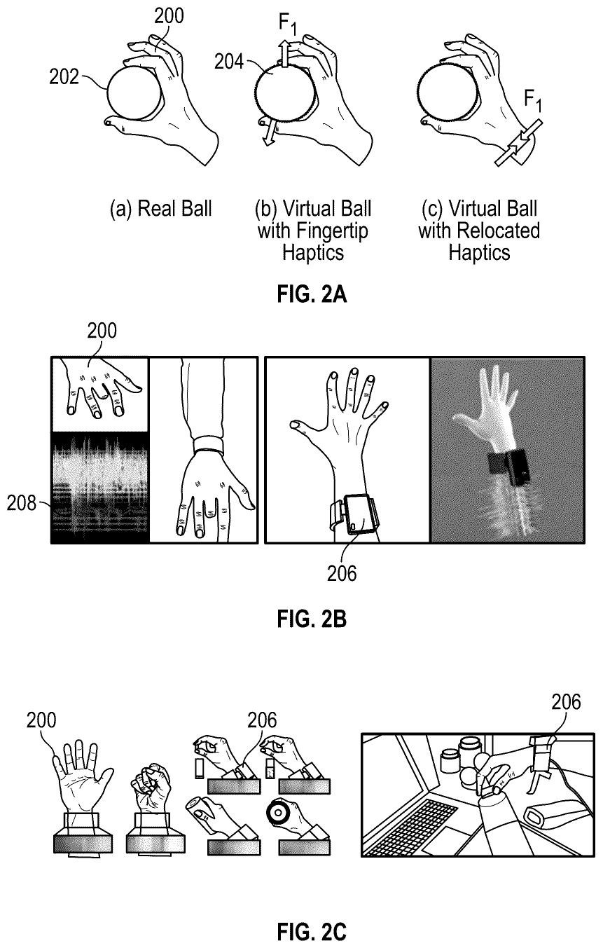

FIG. 2A shows an illustrative example of generating tactile feedback to a wrist of a user, in accordance with some embodiments of this disclosure. In some embodiments, wrist-worn haptic devices deliver tactile feedback directly to a wrist of a user (e.g., user 200, where user 200 may correspond to user 100 of FIG. 1) to simulate the feel of interactions with physical objects (e.g., real ball 202). These devices may employ mechanisms, such as, for example, normal and shear skin deformations to create the perception of touch, guiding users through force and motion cues. User 200 may perceive normal forces (perpendicular forces) as more intense than shear forces (parallel forces), a finding that may be leveraged for designing effective haptic feedback systems. For example, a system (e.g., the system described above in connection with FIG. 1) may instruct a wrist device worn by user 200 (e.g., device 104 of FIG. 1) to generate normal forces and/or shear forces when user 200 is “holding” virtual ball 204. Such feedback not only enhances the realism of virtual interactions but can also be adapted to provide corrective guidance in applications like virtual makeup, where simulating the tactile feel of brushes, sponges, or other tools helps enhance the user's experience. Together, these offer a foundation for integrating wrist-worn technologies into immersive user interfaces, and may help provide more precise user interfaces.

FIG. 2B shows an illustrative example of using electromyography (EMG) data to detect user position and muscle activities, in accordance with some embodiments of this disclosure. In some embodiments, EMG data is used by a system (e.g., the system as described above in connection with FIG. 1) to measure finger position and muscle activity of a user (e.g., user 200) resulting from applying pressure. In some implementations, EMG sensors, which may be integrated into a wrist-worn device (e.g., device 206), measure the electrical impulses on the skin surface produced during muscle contractions, providing an effective, compact, and low-powered way to detect muscle activity. When used to detect finger pose and muscle activity, detected EMG data represents a cumulative bioelectric signal (e.g., signals 208) representing the force of the fingers. EMG data may be collected from an array of sensors consistently placed around the wrist or forearm of user 200. This form factor may be used by the system to distinguish between patterns of EMG activity that correspond to various muscle groups. Analysis of EMG data may help reveal the degree to which different muscle groups are active.

FIG. 2C shows an illustrative example of detecting changes in wrist positioning and muscle activities using capacitance, in accordance with some embodiments of this disclosure. Device 206 may comprise at least one capacitive sensor. A system (e.g., the system as described above in connection with FIG. 1) may use capacitive data, received from the at least one capacitive sensor, to determine a force or forces being applied by user 200. User 200 may, for example, interact with an object by picking up, grasping, twisting, any other suitable interaction, or any suitable combination thereof. User 200 may also produce force without applying the force to an object. The system may receive this digital input on unaugmented, physical objects via device 206.

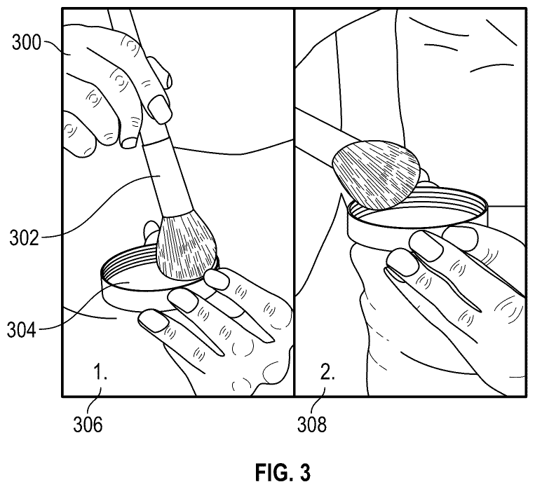

FIG. 3 shows an illustrative example of picking up virtual makeup from a container, in accordance with some embodiments of this disclosure. Picking up makeup may refer to a finger or makeup tool (e.g., brush 302) picking up product from a makeup container before applying it (e.g., as shown at 306). Pick up methods vary from product to product and user to user, and a single type of product (e.g., foundation) may have many different pickup methods. For example, foundation may be picked up from a makeup container or the back of a hand using a brush, sponge, or fingers. Too much or too little product applied unevenly to a finger or brush may not provide the desired effect. A system (e.g., the system of FIG. 1 and/or FIGS. 2A-2C) may simulate picking up makeup by precise tracking of a user's fingers (e.g., user 300) as well as how much force is being applied to the container (e.g., container 304). In some embodiments, the system applies an XR effect (e.g., as described above in connection with FIG. 1) by identifying container 304 in proximity of user 300.

In some embodiments, the system may identify the style and shape of container 304 and arrange container 304 in one or more of various ways. For example, if using a touch display of a device configured as a virtual mirror showing a reflection of user 300, the system may arrange virtual makeup containers on the mirror surface. In this case, the system may detect touch force via wrist-worn sensors, force sensors in the touch display, any other suitable force detection technique, or any suitable combination thereof. In some embodiments, the system detects, based at least in part on a video of user 300 (e.g., the obtained video as described in FIG. 1), a gesture made by user 300 to pick up an amount of virtual makeup from container 304. The system may apply the XR effect based on the amount of virtual makeup picked up from container 304.

In some embodiments, if user 300 is wearing AR glasses capable of spatial tracking, the system may appear to embed makeup containers into a surface such as a table, such that the top layer of makeup product is even with the tabletop. In this case, the system may determine the force being applied using wrist-worn sensors. In both cases, the detected amount of force applied to the virtual makeup container may determine how much virtual makeup is picked up. In some implementations, the system may help enable user 300 to remove excess makeup from their makeup tool (e.g., finger, brush, sponge, puff, or any other suitable makeup tool) by tapping it against the container (e.g., as shown at 308). The amount of makeup the system removes may be based at least in part on a speed of the tool at the time of the tap or the rate of deceleration of the tap.

One technique for applying liquid foundation is to deposit small amounts in different spots around the face and then spread it to the rest of the face from those spots. This approach may be more consistent than depositing a large amount of liquid foundation to a single spot on the face. This approach may also be faster than constantly picking up tiny amounts from the makeup container. The system may simulate this technique by detecting the amount of makeup picked up, e.g., at 306, and identifying the technique used to deposit it. The system may define a threshold amount of virtual makeup for each makeup type (e.g., foundation, blush, eyeshadow, any other suitable makeup type, or any combination thereof) and determine whether the amount of picked up makeup exceeds that amount. In this case, the system may switch to “deposit mode” and only permit the user to deposit, rather than apply, the large amount of makeup.

In some embodiments, the system may determine that the user wishes to deposit rather than apply makeup based on detected finger force and interactions with the face. For example, a quick light tap with a fingertip may indicate depositing a small amount of liquid foundation. Once the makeup has been deposited, user 300 may either spread out the makeup or pick up even smaller amounts to be applied elsewhere. Another technique involves placing certain makeup products (e.g., foundation, concealer) on one hand and using the other hand to pick up and apply it. This approach may speed up makeup application by enabling a user to pick up makeup product close to their face, rather than having to repeatedly pick up from a makeup container on a surface. The system may apply the techniques described above to enable a user to deposit makeup on one hand and pick it up with the other.

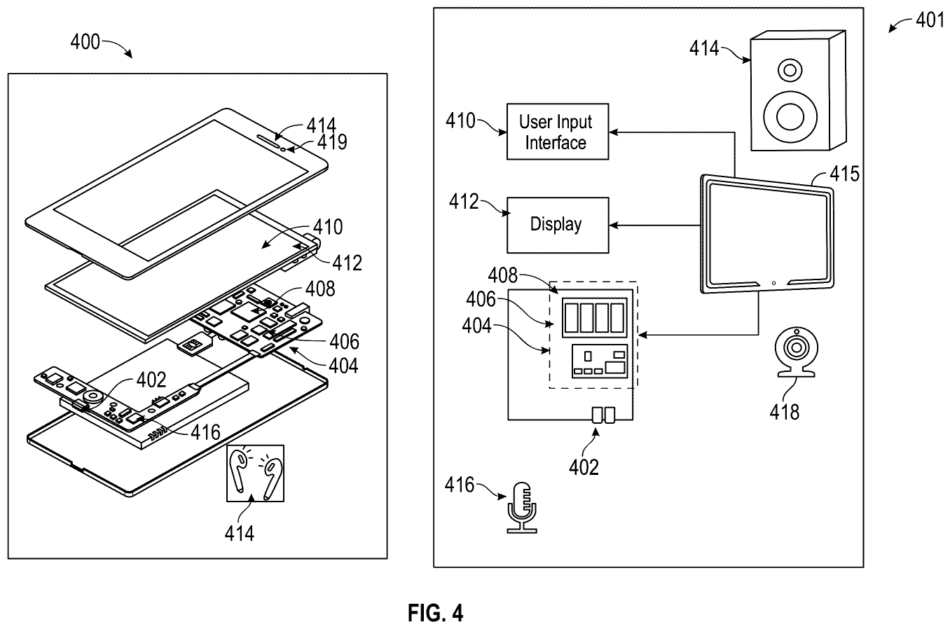

FIGS. 4-5 describe illustrative devices, systems, servers, and related hardware for applying an XR effect to a user, in accordance with some embodiments of the present disclosure. FIG. 4 shows generalized embodiments of illustrative user equipment 400 and 401, which may correspond to, e.g., user device 102 of FIG. 1. For example, user equipment 400 may be a smartphone device, a tablet, a near-eye display device, an XR device, or any other suitable device capable of participating in a XR environment, e.g., locally or over a communication network. In another example, user equipment 401 may be a user television equipment system or device. User equipment 401 may include smart mirror 415. Smart mirror 415 may be communicatively connected to microphone 416, audio output equipment 414 (e.g., speaker or headphones), and display 412. In some embodiments, microphone 416 may receive audio corresponding to a voice of a user and/or ambient audio data. In some embodiments, display 412 may be a television display or a computer display. In some embodiments, smart mirror 415 may be communicatively connected to user input interface 410. In some embodiments, user input interface 410 may be a remote-control device. Smart mirror 415 may include one or more circuit boards. In some embodiments, the circuit boards may include control circuitry, processing circuitry, and storage (e.g., RAM, ROM, hard disk, removable disk, etc.). In some embodiments, the circuit boards may include an input/output path. More specific implementations of user equipment are discussed below in connection with FIG. 4. In some embodiments, user equipment 400 may comprise any suitable number of sensors (e.g., gyroscope or gyrometer, or accelerometer, etc.), and/or a GPS module (e.g., in communication with one or more servers and/or cell towers and/or satellites) to ascertain a location of user equipment 400. In some embodiments, user equipment 400 and/or 401 comprises a rechargeable battery that is configured to provide power to the components of the device.

Each one of user equipment 400 and user equipment 401 may receive content and data via input/output (I/O) path 402. I/O path 402 may provide content (e.g., on-demand programming, internet content, content available over a local area network (LAN) or wide area network (WAN), and/or other content) and data to control circuitry 404, which may comprise processing circuitry 406 and storage 408. Control circuitry 404 may be used to send and receive commands, requests, and other suitable data using I/O path 402, which may comprise I/O circuitry. I/O path 402 may connect control circuitry 404 to one or more communications paths (described below). I/O functions may be provided by one or more of these communications paths but are shown as a single path in FIG. 5 to avoid overcomplicating the drawing. While smart mirror 415 is shown in FIG. 4 for illustration, any suitable computing device having processing circuitry, control circuitry, and storage may be used in accordance with the present disclosure. For example, smart mirror 415 may be replaced by, or complemented by, a personal computer (e.g., a notebook, a laptop, a desktop), a smartphone (e.g., user equipment 400), an XR device, a tablet, a network-based server hosting a user-accessible client device, a non-user-owned device, any other suitable device, or any combination thereof.

Control circuitry 404 may be based on any suitable control circuitry such as processing circuitry 406. As referred to herein, control circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, control circuitry may be distributed across multiple separate processors or processing units, for example, multiple of the same type of processing units (e.g., two Intel Core i7 processors) or multiple different processors (e.g., an Intel Core i6 processor and an Intel Core i7 processor). In some embodiments, control circuitry 404 executes instructions for the system (as described in connection with FIGS. 1-2) stored in memory (e.g., storage 408). Specifically, control circuitry 404 may be instructed by the system to perform the functions discussed above and below. In some implementations, processing or actions performed by control circuitry 404 may be based on instructions received from the system.

In client/server-based embodiments, control circuitry 404 may include communications circuitry suitable for communicating with a server or other networks or servers. The system may be a stand-alone application implemented on a device or a server. The application may be implemented as software or a set of executable instructions. The instructions for performing any of the embodiments discussed herein of the application may be encoded on non-transitory computer-readable media (e.g., a hard drive, random-access memory on a DRAM integrated circuit, read-only memory on a BLU-RAY disk, etc.). For example, in FIG. 4, the instructions may be stored in storage 408, and executed by control circuitry 404 of a user equipment 400.

In some embodiments, the application may be a client/server application where only the client application resides on user equipment 400, and a server application resides on an external server (e.g., server 504 and/or media content source 502). For example, the application may be implemented partially as a client application on control circuitry 404 of user equipment 400 and partially on server 504 as a server application running on control circuitry 511. Server 504 may be a part of a local area network with one or more of user equipment 400, 401 or may be part of a cloud computing environment accessed via the internet. In a cloud computing environment, various types of computing services for performing searches on the internet or informational databases, providing video communication capabilities, providing storage (e.g., for a database) or parsing data are provided by a collection of network-accessible computing and storage resources (e.g., server 504 and/or an edge computing device), referred to as “the cloud.” User equipment 400 may be a cloud client that relies on the cloud computing capabilities from server 504 to generate personalized engagement options in a VR environment.

Control circuitry 404 may include communications circuitry suitable for communicating with a server, edge computing systems and devices, a table or database server, or other networks or servers. The instructions for carrying out the above-mentioned functionality may be stored on a server (which is described in more detail in connection with FIG. 5). Communications circuitry may include a cable modem, an integrated services digital network (ISDN) modem, a digital subscriber line (DSL) modem, a telephone modem, an Ethernet card, or a wireless modem for communications with other equipment, or any other suitable communications circuitry. Such communications may involve the internet or any other suitable communication networks or paths (which is described in more detail in connection with FIG. 5). In addition, communications circuitry may include circuitry that enables peer-to-peer communication of user equipment, or communication of user equipment in locations remote from each other (described in more detail below).

Memory may be an electronic storage device provided as storage 408 that is part of control circuitry 404. As referred to herein, the phrase “electronic storage device” or “storage device” should be understood to mean any device for storing electronic data, computer software, or firmware, such as random-access memory, read-only memory, hard drives, optical drives, digital video disc (DVD) recorders, compact disc (CD) recorders, BLU-RAY disc (BD) recorders, BLU-RAY 3D disc recorders, digital video recorders (DVRs, sometimes called personal video recorders, or PVRs), solid state devices, quantum storage devices, gaming consoles, gaming media, or any other suitable fixed or removable storage devices, and/or any combination of the same. Storage 408 may be used to store various types of content described herein as well as application data described above. Nonvolatile memory may also be used (e.g., to launch a boot-up routine and other instructions). Cloud-based storage, described in relation to FIG. 4, may be used to supplement storage 408 or instead of storage 408. Non-transitory memory may store instructions that, when executed by control circuitry, I/O circuitry, any other suitable circuitry or combination thereof, executes functions of an application as described above.

Control circuitry 404 may include video generating circuitry and tuning circuitry, such as one or more analog tuners, one or more MPEG-2 decoders or HEVC decoders or any other suitable digital decoding circuitry, high-definition tuners, or any other suitable tuning or video circuits or combinations of such circuits. Encoding circuitry (e.g., for converting over-the-air, analog, or digital signals to MPEG or HEVC or any other suitable signals for storage) may also be provided. Control circuitry 404 may also include scaler circuitry for upconverting and downconverting content into the preferred output format of user equipment 400. Control circuitry 404 may also include digital-to-analog converter circuitry and analog-to-digital converter circuitry for converting between digital and analog signals. The tuning and encoding circuitry may be used by user equipment 400, 401 to receive and to display, to play, or to record content. The tuning and encoding circuitry may also be used to receive video communication session data. The circuitry described herein, including, for example, the tuning, video generating, encoding, decoding, encrypting, decrypting, scaler, and analog/digital circuitry, may be implemented using software running on one or more general purpose or specialized processors. Multiple tuners may be provided to handle simultaneous tuning functions (e.g., watch and record functions, picture-in-picture (PIP) functions, multiple-tuner recording, etc.). If storage 408 is provided as a separate device from user equipment 400, the tuning and encoding circuitry (including multiple tuners) may be associated with storage 408.

Control circuitry 404 may receive instruction from a user by way of user input interface 410. User input interface 410 may be any suitable user interface, such as a remote control, mouse, trackball, keypad, keyboard, touch screen, touchpad, stylus input, joystick, voice recognition interface, or other user input interfaces. Control circuitry 404 may be configured to detect gestures of a user and/or detect the eye-gaze of a user. Display 412 may be provided as a stand-alone device or integrated with other elements of each one of user equipment 400 and user equipment 401. For example, display 412 may be a touchscreen or touch-sensitive display. In such circumstances, user input interface 410 may be integrated with or combined with display 412. In some embodiments, user input interface 410 includes a remote-control device having one or more microphones, buttons, keypads, any other components configured to receive user input or combinations thereof. For example, user input interface 410 may include a handheld remote-control device having an alphanumeric keypad and option buttons. In a further example, user input interface 410 may include a handheld remote-control device having a microphone and control circuitry configured to receive and identify voice commands and transmit information to set-top box 415.

Audio output equipment 414 may be integrated with or combined with display 412. Display 412 may be one or more of a monitor, television, liquid crystal display (LCD) for a mobile device, amorphous silicon display, low-temperature polysilicon display, electronic ink display, electrophoretic display, active matrix display, electro-wetting display, electro-fluidic display, cathode ray tube display, light-emitting diode display, electroluminescent display, plasma display panel, high-performance addressing display, thin-film transistor display, organic light-emitting diode display, surface-conduction electron-emitter display (SED), laser television, carbon nanotubes, quantum dot display, interferometric modulator display, or any other suitable equipment for displaying visual images. A video card or graphics card may generate the output to the display 412. Audio output equipment 414 may be provided as integrated with other elements of each one of user equipment 400 and user equipment 401 or may be stand-alone units. An audio component of videos and other content displayed on display 412 may be played through speakers (or headphones) of audio output equipment 414. In some embodiments, audio may be distributed to a receiver (not shown), which processes and outputs the audio via speakers of audio output equipment 414. In some embodiments, for example, control circuitry 404 is configured to provide audio cues to a user, or other audio feedback to a user, using speakers of audio output equipment 414. There may be a separate microphone 416 or audio output equipment 414 may include a microphone configured to receive audio input such as voice commands or speech. For example, a user may speak letters or words that are received by the microphone and converted to text by control circuitry 404. In a further example, a user may voice commands that are received by a microphone and recognized by control circuitry 404. Camera 418 may be any suitable video camera integrated with the equipment or externally connected. Camera 418 may be a digital camera comprising a charge-coupled device (CCD) and/or a complementary metal-oxide semiconductor (CMOS) image sensor. Camera 418 may be an analog camera that converts to digital images via a video card.

The application may be implemented using any suitable architecture. For example, it may be a stand-alone application wholly implemented on each one of user equipment 400 and user equipment 401. In such an approach, instructions of the application may be stored locally (e.g., in storage 408), and data for use by the application is downloaded on a periodic basis (e.g., from an out-of-band feed, from an internet resource, or using another suitable approach). Control circuitry 404 may retrieve instructions of the application from storage 408 and process the instructions to provide video conferencing functionality and generate any of the displays discussed herein. Based on the processed instructions, control circuitry 404 may determine what action to perform when input is received from user input interface 410. For example, movement of a cursor on a display up/down may be indicated by the processed instructions when user input interface 410 indicates that an up/down button was selected. An application and/or any instructions for performing any of the embodiments discussed herein may be encoded on computer-readable media. Computer-readable media includes any media capable of storing data. The computer-readable media may be non-transitory including, but not limited to, volatile and non-volatile computer memory or storage devices such as a hard disk, floppy disk, USB drive, DVD, CD, media card, register memory, processor cache, random access memory (RAM), etc.

Control circuitry 404 may allow a user to provide user profile information or may automatically compile user profile information. For example, control circuitry 404 may access and monitor network data, video data, audio data, processing data, content consumption data, and/or any other suitable data being accessed by a first user (e.g., user 100 of FIG. 1). Control circuitry 404 may obtain all or part of other user profiles that are related to a particular user (e.g., via social media networks), and/or obtain information about the user from other sources that control circuitry 404 may access. As a result, a user can be provided with a unified experience across the user's different devices.

In some embodiments, the application is a client/server-based application. Data for use by a thick or thin client implemented on each one of user equipment 400 and user equipment 401 may be retrieved on demand by issuing requests to a server remote to each one of user equipment 400 and user equipment 401. For example, the remote server may store the instructions for the application in a storage device. The remote server may process the stored instructions using circuitry (e.g., control circuitry 404) and generate the displays discussed above and below. The client device may receive the displays generated by the remote server and may display the content of the displays locally on user equipment 400. This way, the processing of the instructions is performed remotely by the server while the resulting displays (e.g., that may include text, a keyboard, or other visuals) are provided locally on user equipment 400. User equipment 400 may receive inputs from the user via user input interface 410 and transmit those inputs to the remote server for processing and generating the corresponding displays. For example, user equipment 400 may transmit a communication to the remote server indicating that an up/down button was selected via user input interface 410. The remote server may process instructions in accordance with that input and generate a display of the application corresponding to the input (e.g., a display that moves a cursor up/down). The generated display is then transmitted to user equipment 400 for presentation to the user.

In some embodiments, the application may be downloaded and interpreted or otherwise run by an interpreter or virtual machine (run by control circuitry 404). In some embodiments, the application may be encoded in the ETV Binary Interchange Format (EBIF), received by control circuitry 404 as part of a suitable feed, and interpreted by a user agent running on control circuitry 404. For example, the application may be an EBIF application. In some embodiments, the application may be defined by a series of JAVA-based files that are received and run by a local virtual machine or other suitable middleware executed by control circuitry 404. In some of such embodiments (e.g., those employing MPEG-2, MPEG-4, HEVC or any other suitable digital media encoding schemes), the application may be, for example, encoded and transmitted in an MPEG-2 object carousel with the MPEG audio and video packets of a program.

As shown in FIG. 5, user equipment 501 (e.g., a smart watch), 506, 507, 508, 510 (which may correspond to user equipment, e.g., user device 102 of FIG. 1) may be coupled to communication network 509. In some embodiments, one or more of the user equipment may correspond to wearable sensors and/or haptic devices. Communication network 509 may be one or more networks including the internet, a mobile phone network, mobile voice or data network (e.g., a 5G, 4G, or LTE network), cable network, public switched telephone network, or other types of communication network or combinations of communication networks. Paths (e.g., depicted as arrows connecting the respective devices to the communication network 509) may separately or together include one or more communications paths, such as a satellite path, a fiber-optic path, a cable path, a path that supports internet communications (e.g., IPTV), free-space connections (e.g., for broadcast or other wireless signals), or any other suitable wired or wireless communications path or combination of such paths. Communications with the client devices may be provided by one or more of these communications paths but are shown as a single path in FIG. 5 to avoid overcomplicating the drawing.

Although communications paths are not drawn between user equipment, these devices may communicate directly with each other via communications paths as well as other short-range, point-to-point communications paths, such as USB cables, IEEE 1394 cables, wireless paths (e.g., Bluetooth, infrared, IEEE 702-11x, etc.), or other short-range communication via wired or wireless paths. The user equipment may also communicate with each other directly through an indirect path via communication network 509.

System 500 may comprise media content source 502, one or more servers 504, and/or one or more edge computing devices. In some embodiments, the application may be executed at one or more of control circuitry 511 of server 504 (and/or control circuitry of user equipment 501, 506, 507, 508, 510 and/or control circuitry of one or more edge computing devices). In some embodiments, the media content source and/or server 504 may be configured to host or otherwise facilitate video communication sessions between user equipment 501, 506, 507, 508, 510 and/or any other suitable user equipment, and/or host or otherwise be in communication (e.g., over communication network 509) with one or more social network services.

In some embodiments, server 504 may include control circuitry 511 and storage 514 (e.g., RAM, ROM, Hard Disk, Removable Disk, etc.). Storage 514 may store one or more databases. Server 504 may also include an I/O path 512. In some embodiments, I/O path 512 is an I/O circuitry. I/O circuitry may be a network interface card, audio output device, mouse, keyboard card, any other suitable I/O circuitry device or combination thereof. I/O path 512 may provide video conferencing data, device information, or other data, over an LAN or WAN, and/or other content and data to control circuitry 511, which may include processing circuitry, and storage 514. Control circuitry 511 may be used to send and receive commands, requests, and other suitable data using I/O path 512, which may comprise I/O circuitry. I/O path 512 may connect control circuitry 511 to one or more communications paths.

Control circuitry 511 may be based on any suitable control circuitry such as one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, control circuitry 511 may be distributed across multiple separate processors or processing units, for example, multiple of the same type of processing units (e.g., two Intel Core i7 processors) or multiple different processors (e.g., an Intel Core i6 processor and an Intel Core i7 processor). In some embodiments, control circuitry 511 executes instructions for an emulation system application stored in memory (e.g., the storage 514). Memory may be an electronic storage device provided as storage 514 that is part of control circuitry 511. Memory may store instruction to run the application.

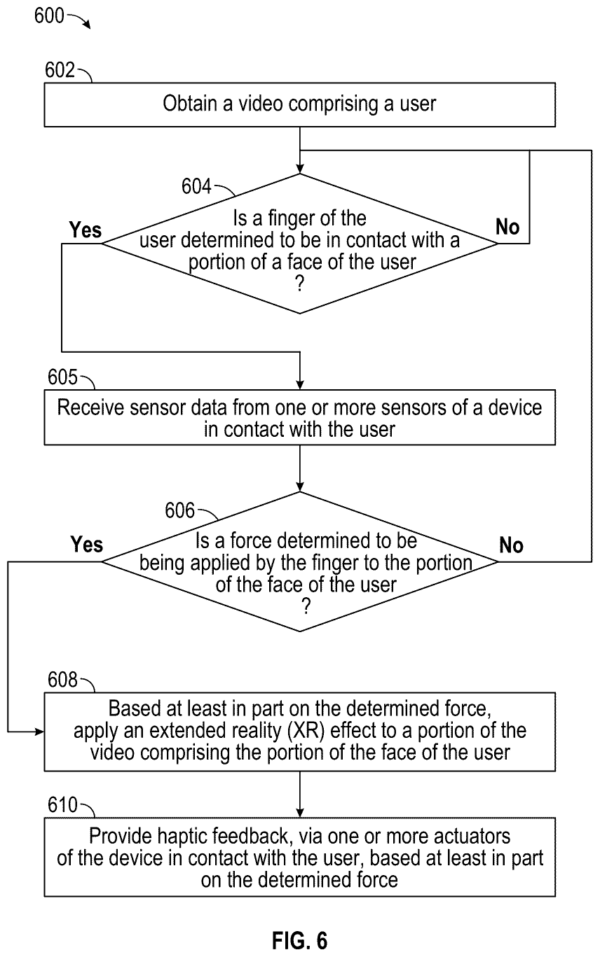

FIG. 6 is a flowchart of a detailed illustrative process for applying an XR effect to a user, in accordance with some embodiments of this disclosure. In various embodiments, the individual steps of process 600 may be implemented by one or more components of the devices, methods, and systems of FIG. 1 and FIGS. 4-5, and may be performed in combination with any of the other processes and aspects described herein. Although the present disclosure may describe certain steps of process 600 (and of other processes described herein) as being implemented by certain components of the devices, methods, and systems of FIG. 1 and FIGS. 4-5, this is for purposes of illustration only, and it should be understood that other components of the devices, methods, and systems of FIG. 2-3 and FIGS. 7-10 may implement those steps instead.

In some embodiments, at 602, control circuitry (e.g., control circuitry 404 of FIG. 4 and/or control circuitry 511 of FIG. 5) obtains a video comprising a user. In some implementations, at 604, control circuitry determines whether, based at least in part on the video, a finger of the user is in contact with a portion of a face of the user. If control circuitry determines that a finger of the user is not in contact with a portion of the face of the user, control circuitry may repeat 604. If control circuitry determines that a finger of the user is in contact with a portion of the face of the user, control circuitry may proceed to 605. In some embodiments, at 605, control circuitry receives sensor data from one or more sensors of a device in contact with the user. In some embodiments, at 606, control circuitry determines whether a force is being applied by the finger to the portion of the face of the user. Control circuitry may determine whether the force is being applied based at least in part on the received sensor data from the device in contact with the user. If control circuitry determines that a force is not being applied by the finger to the portion of the face of the user, control circuitry may return to 604.

If control circuitry determines that a force is being applied by the finger to the portion of the face of the user, control circuitry may proceed to 608. In some implementations, at 608, control circuitry, based at least in part on the determined force, applies an XR effect to a portion of the video comprising the portion of the face of the user. In some embodiments, at 610, control circuitry provides haptic feedback, via one or more actuators of the device in contact with the user, based at least in part on the determined force. In some embodiments, control circuitry provides haptic feedback based at least in part on the obtained video comprising the user.

FIG. 7 is a flowchart of a detailed illustrative process for computing contact area and deformation from sensor input, in accordance with some embodiments of this disclosure. In various embodiments, the individual steps of process 700 may be implemented by one or more components of the devices, methods, and systems of FIG. 1 and FIGS. 4-5, and may be performed in combination with any of the other processes and aspects described herein.

Although the present disclosure may describe certain steps of process 700 (and of other processes described herein) as being implemented by certain components of the devices, methods, and systems of FIG. 1 and FIGS. 4-5, this is for purposes of illustration only, and it should be understood that other components of the devices, methods, and systems of FIGS. 2A-2C, 3, 6, and FIGS. 8-10 may implement those steps instead.

In some embodiments, at 702, control circuitry (e.g., control circuitry 404 of FIG. 4 and/or control circuitry 511 of FIG. 5) initializes sensors (e.g., RGB, infrared (IR), etc.). To achieve highly accurate fingertip and facial surface tracking, control circuitry may combine multiple sensors and imaging modalities. In some embodiments, control circuitry may use RGB cameras with high resolution and high frame rate. RGB cameras may capture the color and texture of both the face and hands. High temporal resolution (e.g., 60-120 frames per second) may help ensure smooth tracking of rapid finger movements and subtle facial changes. In some implementations, control circuitry may be in communication with and receive image data from IR structured light/time-of-flight (ToF) cameras, which may project a known pattern (e.g., IR dot patterns) onto the scene. By analyzing the distortion of these patterns, control circuitry may reconstruct a dense 3D map of the user's face and hand, including the fingertips. This 3D geometry provides data about surface contours, depressions, and protrusions caused by finger pressure on the face.

In some embodiments, control circuitry may use near-infrared (NIR) cameras and active illumination to help reduce the effects of ambient lighting. A controlled NIR environment may help ensure consistent illumination and reduce shadows and specular highlights, improving the reliability of 3D reconstruction and skin deformation analysis. In some embodiments, control circuitry may place subtle IR-only fiducials around the periphery of the face and fingers (outside the visible spectrum) to help maintain consistent face and hand tracking and aid in calibration. The IR-only fiducials remain invisible to the user but provide control circuitry with stable reference points for 3D alignment. In some implementations, at 704, control circuitry captures RGB and IR depth frames. In some embodiments, at 706, control circuitry detects a face in a captured RGB frame (e.g., via a deep learning-based face detector such as YOLO/RetinaFace, or a modified version thereof, or any other suitable model). Control circuitry may user a deep learning-based face detector on the RGB feed to establish a bounding box for the user's face.

In some embodiments, at 708, control circuitry fits a three-dimensional (3D) morphable face model (e.g., using a Basel Face Model or parametric template, a suitable modification thereof, or any other suitable model) using depth and RGB data to localize 3D facial landmarks. Control circuitry may leverage a suitable combination of depth and RGB data for a robust, non-rigid registration process to align the 3D morphable face model to the user's current face shape in real time. Such aspects yield a stable 3D reference frame for each facial region. In some embodiments, while the 3D face model is being tracked, control circuitry runs another computer vision algorithm for hand and finger detection. In some embodiments, at 710, control circuitry detects hand and finger landmarks (e.g., MediaPipe Hands, or a suitable modification thereof, or any other suitable model). In some implementations, control circuitry performs hand pose estimation by applying neural network-based hand detectors and landmark models (e.g., MediaPipe Hands, OpenPose for hands, a suitable modification thereof, or any other suitable model) to the RGB feed to identify the user's wrist and finger joints. Such aspects provide a set of 2D keypoints for each finger.

In some implementations, at 712, control circuitry combines two-dimensional (2D) keypoints with IR depth data for 3D hand reconstruction. Control circuitry may use a triangulation or model-based fitting approach (e.g., MANO hand model, a suitable modification thereof, or any other suitable model) to reconstruct the full 3D pose of the hand and each fingertip. This may include each finger's orientation, bend, and twist. In some embodiments, control circuitry reconstructs the 3D mesh representation of the hand, including all the fingers. In some embodiments, at 714, control circuitry applies temporal filtering (Kalman/Particle Filters) to fuse data from RGB, IR depth, and/or NIR cameras and perform temporal tracking and temporal smoothing. Such aspects may help provide stable, low-latency tracking of rapid finger movements. In some implementations, control circuitry performs temporal tracking by detection approach to associate the detected and reconstructed 3D shape of the face and fingers in image sequences. The result may be a real-time stream of data that provides precise 3D positions and orientations of each fingertip relative to the face's coordinate frame. Once the finger's location is known, control circuitry may detect contact and measure its properties.

In some implementations, at 716, control circuitry determines whether a fingertip is close to the face surface. If control circuitry determines, at 716, that a fingertip is not close to the face surface, control circuitry may proceed to 718. In some embodiments, at 718, control circuitry does not perform a touch or deformation computation. At 720, control circuitry may continue tracking and face/hand updates. If control circuitry determines, at 716, that a fingertip is close to the face surface, control circuitry may proceed to 722. In some implementations, at 722, control circuitry checks minimal distance between fingertip mesh (or fingertip point cloud) and face mesh derived from depth sensors. At 724, control circuitry may determine whether the minimal distance is less than a threshold distance. If, at 724, control circuitry determines that the minimal distance is more than the threshold distance, control circuitry may determine that there was no touch between the fingertip and the face and proceed to 726. At 726, control circuitry may not perform a contact area computation and, at 728, may continue tracking the minimal distance. If, at 724, control circuitry determines that the minimal distance is less than the threshold distance, control circuitry may determine that there was a touch detected and proceed to 730. At 730, control circuitry may register a “touch” event.

In some embodiments, at 732, control circuitry analyzes fingertip deformation (e.g., flattening/widening). For example, for finger pad deformation, the soft tissue at the fingertip may flatten and widen upon pressure. Control circuitry may track the increase in the fingertip's contact patch area by analyzing the fingertip's depth profile. Using a parametric model of fingertip compliance (derived from user-specific calibration), depth data from IR sensors may reveal how the fingertip contour flattens. In some implementations, at 734, control circuitry compares the current face mesh to a baseline (no-contact) mesh. In some embodiments, at 736, control circuitry detects local indentation on the face surface. Control circuitry may use techniques such as, for example, iterative closest point (ICP) fitting and difference maps to highlight local surface changes.

In some implementations, control circuitry determines the contact area by first analyzing the point cloud and extract a subset of the face's 3D points where the fingertip hovers. Control circuitry may consider points that register a geometric displacement (indentation) above a certain threshold within the contact zone. Control circuitry may fit a closed 2D contour on the face surface based on the detected indentation points. In some implementations, at 738, control circuitry extracts indentation points and computes contact area contour. This contour may represent the approximate area of skin-fingertip contact. In some embodiments, control circuitry performs surface normal and curvature analysis on the contact region by evaluating the changes in surface normals. A flatter area may indicate stronger pressure and a larger contact patch. At 740, control circuitry may compute the contact area and/or indentation depth. Control circuitry may further quantify the deformed area by performing a 2D projection of the identified contact region onto a plane tangent to the face surface at the point of contact.

In some implementations, control circuitry computes the polygonal area to get a numerical measure of the fingertip's contact size. In some embodiments, control circuitry approximates the volume of indentation by integrating the depth differences from a baseline (no-contact) mesh. Such aspects provide data of how much the facial skin is “pushed in,” correlating to pressure level. Process 700 may be implemented with a machine learning based method. For example, control circuitry may train neural networks or regression models on labeled data sets of fingertip-and face-contact scenarios. The model may take the following as input: 3D coordinates of fingertip and facial surface points, depth images of the contact region, and possibly other measurements of subtle skin changes. The mode may output a precise estimation of contact area and indentation depth. In some embodiments, at 742, control circuitry optionally refines machine learning (ML) models for skin-finger compliance (e.g., deformability of skin for users generally or specific users) over time. Machine learning models may be developed to continuously adapt to individual user characteristics. Such aspects may improve contact area estimation and deformation accuracy over time. In some embodiments, the control circuitry may receive data related to an oiliness of the user's skin and/or an undertone of the user's skin, and take such data into account when applying XR effects.

To ensure stable and consistent operation in real-world conditions, control circuitry may also consider the following. For lighting variability, control circuitry may rely on IR structured lighting to ensure minimal impact of ambient lighting changes compared to relying on an RGB camera only. Control circuitry may augment the RGB-based landmark detection and tracking by IR-based face and fingertip detection models that are invariant to visible lighting conditions. To handle occlusion, for example, if the user's hand partially occludes the face, control circuitry may rely on depth data for finger position. Control circuitry may achieve advanced occlusion reasoning through temporal continuity and predictive modeling, ensuring that transient occlusions do not break tracking. In some embodiments, the 3D model fitting is robust to partial observations, and the information from the previous observation may also help control circuitry to estimate the 3D information of the occluded area. In some implementations, control circuitry utilizes personalization and calibration to enable the system to be more robust and adaptive to the same user over time or various users over time. For example, an initial calibration phase may measure a user's normal fingertip thickness, elasticity, and baseline facial mesh.

FIG. 8 is a flowchart of a detailed illustrative process for estimating the force exerted by a fingertip on a user's face, in accordance with some embodiments of this disclosure. In various embodiments, the individual steps of process 800 may be implemented by one or more components of the devices, methods, and systems of FIG. 1 and FIGS. 4-5, and may be performed in combination with any of the other processes and aspects described herein. Although the present disclosure may describe certain steps of process 800 (and of other processes described herein) as being implemented by certain components of the devices, methods, and systems of FIG. 1 and FIGS. 4-5, this is for purposes of illustration only, and it should be understood that other components of the devices, methods, and systems of FIGS. 2A-2C, 3, 6-7 and FIGS. 9-10 may implement those steps instead.

In some embodiments, control circuitry (e.g., control circuitry 404 of FIG. 4 and/or control circuitry 511 of FIG. 5) begins process 800 at 802 and performs a vision-based estimation of fingertip and face deformation. When the fingertip presses against the face, both the fingertip's soft tissue and the facial skin deform. The level of deformation may correlate with the amount of force exerted. Control circuitry may obtain this relationship by training a machine learning model with data collected from a large number of users with load cell or force sensitive resistor for both fingertip and the face. In some embodiments, control circuitry measures varying forces (e.g., 0.5 N, 1 N, 2 N, etc.) of a user pressing a physical test surface with the fingertip while recording the corresponding fingertip deformation and depth change. In some implementations, a fingertip-shaped device with force measurement can be used to touch the face and measure the deformation given known varying forces.

Control circuitry may collect the corresponding data of fingertip flattening (change in radius, contact area) and facial indentation depth at each known force level. In some implementations, at 804, control circuitry captures RGB and IR depth frames. In some embodiments, at 806, control circuitry detects face and fingertip position. In some implementations, at 808, control circuitry computes indentation depth δface (difference between baseline face mesh and indented face mesh) and fingertip flattening δfinger (change in fingertip curvature and contact patch area). In some embodiments, at 810, control circuitry defines and applies learned deformation model f(δface, δfinger)=F_vision. Control circuitry may determine a mapping between observed deformations and known forces from the calibration dataset.

In some embodiments, control circuitry begins process 800 at 812 and performs a capacitive-based estimation of fingertip and face deformation. Finger flexion and force application may generate subtle changes in forearm and wrist musculature, altering the wrist's topography. Capacitive sensors around the wrist may detect these shape variations in real time. A user may wear a wristband comprising a circular array of capacitive sensing electrodes around their wrist. In some implementations, at 814, control circuitry reads capacitive electrodes at the wrist. Each electrode may measure changes in capacitance as the distance to the skin and the local dielectric properties change (e.g., due to muscle/tendon bulging). Control circuitry may establish a stable baseline of when the user is relaxing their hand (e.g., no force) to record the baseline capacitive profile. In some embodiments, a vision system detects the user's hand is at rest. In other embodiments, this may be performed as a calibration step.

In some embodiments, at 816, control circuitry filters and extracts features (C). Each electrode may continuously measure capacitance values at a high sampling rate, for example, ~100-200 Hz. The signal may first be filtered using a low-pass filter (e.g., cutoff at ~10-20 Hz) to remove high-frequency noise. It may then subtract baseline and/or apply a sliding window average to reduce drift, before control circuitry performs feature extraction. In some embodiments, control circuitry computes feature vectors from the capacitive sensors (e.g., mean, variance, principal component analysis (PCA) of the electrode readings). The resulting feature vector =[c1, c2, . . ., cn] may capture the wrist's shape changes at any instant. Capacitive sensing relies on having a “ground” as a reference for the electric field. In a wrist-based capacitive sensor, the ground would typically be provided by a sensor on the wrist. Such a ground, however, may change with muscle activity, making it an ineffective reference.

In this case, it's possible to use external grounds provided by any other capacitive sensor making contact with the user's skin. For example, a capacitive sensor integrated with an earbud, phone, headset, or even keyboard may provide a ground sufficiently far enough from the wrist to serve as a consistent reference. Similar to the visual deformation-based estimation method, control circuitry may collect training data to train a machine learning-based model to estimate the force, by using pressing known force levels while recording capacitive signals. With the collected data, control circuitry may train a regression or machine learning model (e.g., linear regression, random forest, or a small neural network) to map capacitive features C to estimated force F_cap=g(C), representing force inferred from wrist shape changes. In some implementations, at 818, control circuitry applies learned model g(C)=F_cap.

In some embodiments, control circuitry begins process 800 at 820 and performs an EMG-based estimation of fingertip and face deformation. EMG sensors measure electrical activity in muscles controlling finger movements. Higher force may correspond to higher muscle activation, which can be captured by EMG signals. To set up, a user may place surface EMG electrodes on the forearm muscles that actuate finger flexion (e.g., flexor digitorum profundus or flexor digitorum superficialis regions), to help provide for stable skin contact and use a reference electrode for signal grounding. In some implementations, at 822, control circuitry acquires EMG signals from the forearm. In some embodiments, at 824, control circuitry filters, rectifies, and computes root mean square (RMS)/Features (E). EMG signals may be sampled at a higher rate (e.g., 1-2 kHz) to capture the muscle's electrical activity. In some embodiments, control circuitry may apply a band-pass filter (e.g., 20-450 Hz) to remove motion artifacts and low-frequency drift.

In some implementations, control circuitry rectifies the EMG signal and computes its RMS or moving average over a short time window (e.g., 50 ms) to produce a stable measure of muscle activation. Similar to the visual deformation-based estimation method, control circuitry may collect training data to train a machine learning-based model to estimate the force by pressing known force levels while recording the RMS EMG signal E. The trained model may be a simple linear regression or a more complex ML model. The trained model may map EMG features to force, e.g., F_emg=h(E), which is a third estimation that correlates muscle activation to applied force. In some implementations, at 826, control circuitry applies learned model h(E)=F_emg.

In some embodiments, after 810, 818, and/or 826, control circuitry proceeds to 830 and determines whether fusion of the three of the force estimation methods is to be performed. Each of the three methods above (vision-based, capacitance-based, and EMG-based force estimation) may produce a partial estimate of force. In some embodiments, at 802, control circuitry determines that fusion is not to be performed and proceeds to 832, where the control circuitry determines to employ a single modality force estimate. In some embodiments, control circuitry determines that fusion is to be performed and proceeds to 834 to fuse any two or more of the following estimation of the force: F_vision from visual deformation cues, F_cap from capacitive wrist sensing, or F_emg from muscle activity signals to obtain a more robust, accurate, and stable force estimation than a single estimate.

In some embodiments, after 834, control circuitry proceeds to 836 and takes a weighted average of each force estimate to fuse the force estimates. In some implementations, at 838, control circuitry assigns different weightsα, β, γ to each estimate based on a confidence value or previously measured accuracy: F_fused=α*F_vision+β*F_cap+γ*F_emg. Control circuitry may dynamically adjust weights based on the situation (e.g., poor lighting may reduce α, while changes in electrode placement may reduce β or γ). In some embodiments, after 834, control circuitry proceeds to 840 to apply a machine learning-based fusion model. For example, control circuitry may use a multivariate regression model or a neural network. Control circuitry may collect data and train the model using the collected data, where ground-truth forces from a force sensor are known. In some implementations, at 842, the machine learning fusion model takes F_vision, F_cap, F_emg as inputs and may take additional contextual features (like finger angle). In some embodiments, at 844, the machine learning fusion model outputs a single fused force estimate, F_fused.

In some embodiments, after 834, control circuitry proceeds to 846 to apply Bayesian or probabilistic fusion. Bayesian or probabilistic fusion may be applied by treating each force estimate as a probability distribution around a mean value. In some implementations, at 848, control circuitry uses a Bayesian framework to combine these distributions into a single posterior estimate, accommodating uncertainties and noise characteristics. In some embodiments, after 838, 844, 848, and/or 832, control circuitry proceeds to 850 and outputs a final force estimate (F_fused or single F). Control circuitry may store data of predicted forces versus user feedback or additional ground-truth references (if available). In some embodiments, at 852, control circuitry trains the machine learning model adaptively and continuously using the stored data. In some embodiments, at 854, control circuitry periodically updates the model over time. Such aspects may improve estimation accuracy over time and adapt to changes in user physiology or sensor placement.

FIG. 9 is a component diagram of a haptic feedback delivery system, in accordance with some embodiments of this disclosure. In various embodiments, the individual components and steps of diagram 900 may be implemented by one or more components of the devices, methods, and systems of FIG. 1 and FIGS. 4-5, and may be performed in combination with any of the other processes and aspects described herein. Although the present disclosure may describe certain steps of diagram 900 (and of other processes described herein) as being implemented by certain components of the devices, methods, and systems of FIG. 1 and FIGS. 4-5, this is for purposes of illustration only, and it should be understood that other components of the devices, methods, and systems of FIGS. 2A-2C, 3, 6-8 and 10 may implement those steps instead.

Delivering haptic feedback involves choosing the right actuators, integrating them mechanically into a wearable band (e.g., bracelet 926), driving them with suitable electronics and microcontroller code, and mapping the estimated force and texture information into vibratory patterns. Bracelet 926 may comprise the components of visual and force estimation, microcontroller and control logic, haptic output, any other suitable components, or any suitable combination thereof. Calibration and iterative refinement ensure the user perceives authentic, synchronized tactile cues that enhance the realism of the virtual makeup application experience. The mechanical actuation system may involve mechanical and electrical integration. On the mechanical side, actuators (e.g., mechanical actuators 922) must be mounted in a stable yet comfortable manner. A wristband (e.g., bracelet 926) with custom-molded pockets or elastic mounts may hold actuators pressed lightly against the skin to ensure efficient transmission of mechanical energy. On the electrical side, haptic driver integrated circuits (e.g., haptic driver IC 918) for LRAs or micro-geared motors may supply stable current and quickly modulate output waveforms.

A microcontroller (e.g., the microcontroller's firmware 914) may communicate with haptic driver 918 IC, e.g., at 916, with control signals via standard communication buses (I²C or SPI). Such aspects may ensure real-time adjustments to vibration amplitude and frequency. The firmware of microcontroller 914 may use sensor fusion outputs (e.g., force estimates from computer vision-based force estimation 902 deformation analysis and wrist sensors (EMG or capacitive) 908 sensors) to dynamically modulate haptic patterns. For example, at 904, computer vision based force estimation 902 provides estimated force and texture to sensor fusion and force model 906. At 910, wrist sensors 908 may provide sensor fusion and force model 906 with wrist signals. When control circuitry detects increasing fingertip pressure, it may raise vibration intensity or alter the temporal pattern of skin deformation to match the changing “feel” of applying more pressure in a physical scenario. Haptic driver IC 918 may provide drive signals (pulse width modulation (PWM)/analog) to mechanical actuators 922.

In some embodiments, control circuitry may use mechanical actuation to deform the skin normal to or along the surface of the wrist. For example, mechanical actuators 922 (e.g., linear resonant actuators (LRAs), eccentric rotating mass (ERM), and/or direct-drive servo motors) may apply normal forces that press against the skin, providing a perceptibly more intense sensation than shear forces. Conversely, shear-based actuators shift the skin laterally, simulating directional cues akin to brush strokes or the gentle dragging of a makeup tools (e.g., sponges, pencils, brushes, or the like) across the face. By adjusting amplitude, frequency, and direction of these mechanical inputs, control circuitry may represent different tactile properties—such as the roughness of a powder-based makeup or the smoother, more viscous feel of a cream foundation. Arranging multiple actuators around the wrist in a ring configuration allows for spatial encoding of haptic cues. For example, activating a sequence of adjacent actuators can create the illusion of motion or direction, representing how a makeup brush might move across the face's surface. For example, at 924, control circuitry, via mechanical actuators 922, provides vibration/normal/shear feedback to bracelet 926.

In some embodiments, electro-tactile feedback provides another modality of haptic feedback. For example, by placing electrodes at the wrist (e.g., wrist sensors 908) and delivering controlled electrical pulses to stimulate underlying nerves (e.g., electrical stim commands at 928), control circuitry may evoke tactile sensations (e.g., electro-tactile sensations at 936) downstream in the hand or fingers. Such aspects effectively “redirect” tactile cues so users perceive them where the virtual interaction occurs (e.g., on the fingertip applying the makeup) even though the actual stimulation hardware (e.g., electro-tactile electrodes 934) sits on the wrist. In some embodiments, specialized waveforms and pulse parameters (amplitude, pulse width, and frequency) are calibrated to ensure safety, avoid discomfort, and achieve a sensation that is both perceivable and convincing. The resulting electro-tactile sensations 936 may be augmented by synchronized visual cues. For example, control circuitry displaying a virtual object pressing against the user's finger in AR while delivering corresponding electro-tactile stimulation at the wrist may lead to a more convincing and immersive haptic experience than electrical stimulation alone.

A control pipeline for implementing electro-tactile feedback may employ the following. For example, microcontroller 914, at 928, sends electrical stim commands to stimulus controller 930. In some embodiments, microcontroller 914 or stimulus controller 930 generates precise electrical waveforms (e.g., electrical pulses at 932) that drive isolated stimulation channels. Isolation and safety measures (e.g., galvanic isolation transformers, current-limiting resistors, and fail-safe shutdown circuits) are implemented to prevent harm. Control circuitry may calibrate stimulus thresholds by gently ramping up the current until the user reports a faint sensation. From that baseline, software algorithms may adapt pulse intensity and patterns in real time, modulated by the computed force and texture cues. Additionally, advanced closed-loop control strategies may fine-tune stimulus parameters based on user feedback, sensor readings, and/or machine learning models that predict the most comfortable and realistic stimulation patterns.

In some embodiments, both mechanical haptic feedback (e.g., from mechanical actuators 922) and electro-tactile haptic feedback (e.g., from electro-tactile electrodes 934) may be employed concurrently or selectively depending on control circuitry requirements, virtual makeup application requirements, and/or user preferences. Mechanical actuators (e.g., mechanical actuators 922) may excel at providing a broad, easily interpretable set of tactile signals, while electro-tactile sensations 936 may add a unique dimension of localized feedback perceived directly in the fingers. By combining these modalities, control circuitry may generate a richer haptic palette. In some embodiments, over time, iterative testing, user studies, and continued refinement of hardware and software parameters may ensure that haptic feedback grows increasingly natural, convincing, and effective. Such aspects may elevate the overall immersion and fidelity of virtual makeup applications.

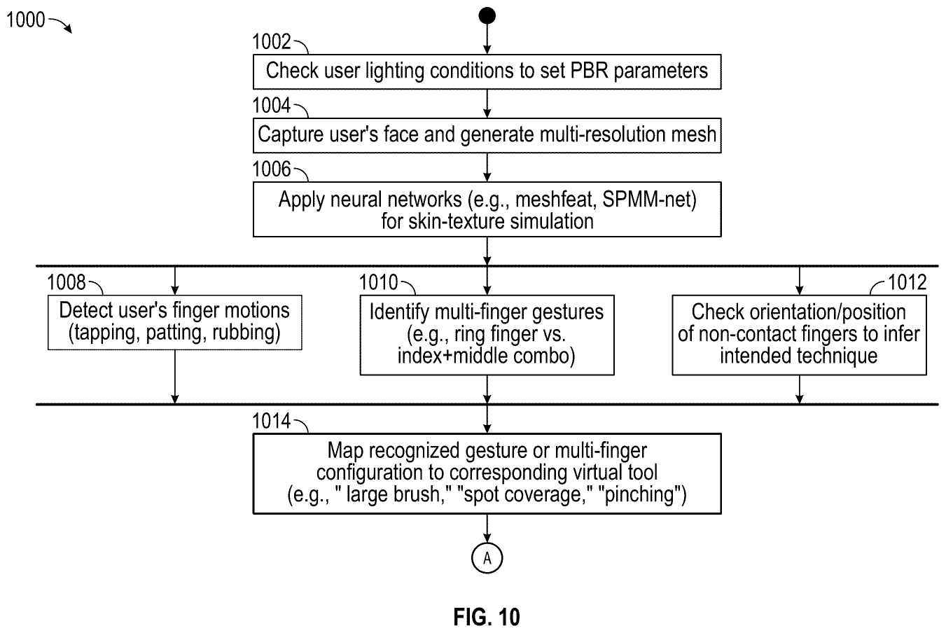

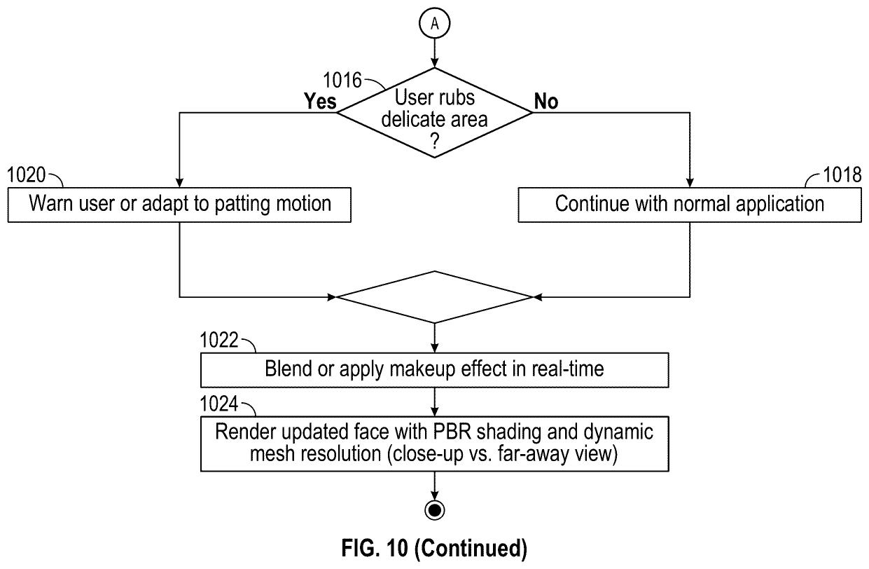

FIG. 10 is a flowchart of a detailed illustrative process for applying virtual makeup using a neural network, in accordance with some embodiments of this disclosure. In various embodiments, the individual steps of process 1000 may be implemented by one or more components of the devices, methods, and systems of FIG. 1 and FIGS. 4-5, and may be performed in combination with any of the other processes and aspects described herein.

Although the present disclosure may describe certain steps of process 1000 (and of other processes described herein) as being implemented by certain components of the devices, methods, and systems of FIG. 1 and FIGS. 4-5, this is for purposes of illustration only, and it should be understood that other components of the devices, methods, and systems of FIGS. 2A-2C, 3 and FIGS. 6-9 may implement those steps instead.

In some embodiments, at 1002, control circuitry (e.g., control circuitry 404 of FIG. 4 and/or control circuitry 511 of FIG. 5) checks user lighting conditions to set physically based shading/rendering (PBR) parameters. Different makeup finishes (e.g., matte, dewy) may look different in various lighting. Control circuitry may use PBR to accurately simulate light effects by representing how light interacts with properties of an object. Deep learning methods such as, for example, PBR-Net, may help to achieve high-quality, photo-realistic images in nearly real time. In some embodiments, the user specifies the situation when makeup is worn (e.g., daily wear, night wear, or party wear). Control circuitry may adapt the light settings accordingly, as the makeup in the lighting that mimics the environment will be helpful in creating suitable looks. For example, heavy foundation may look creasy during daytime, unlike nighttime. If the user applies too much pressure or too much product onto the face with a daily-wear setting selected, control circuitry may provide feedback to lighten the makeup application.

In some implementations, at 1004, control circuitry captures a video of the user's face and generates a multi-resolution mesh. In some embodiments, at 1006, control circuitry applies one or more machine learning models, e.g., one or more neural network (e.g., MeshFeat, SPMM-Net, or suitable modifications thereof), for skin texture simulation. Neural architectures such as MeshFeat and SPMM-Net may process mesh-based 3D data of the face and learn both global patterns (high resolution meshes) like overall skin smoothness and local details (low resolution meshes) like pores and fine lines. Moreover, according to the distance of the face from the camera, high-and low-resolution rendering of the face may be done with the help of dynamic adaptation of mesh resolution using downsampling and upsampling processes in the SPMM-Net. Control circuitry may use a combination of MeshFeat and SPMM-Net or each network individually, or any suitable modifications thereof, and/or any other suitable model or network.

In some embodiments, after 1006, control circuitry proceeds to 1008 and detects the user's finger motions (e.g., tapping, patting, rubbing). Control circuitry may use tapping or patting motions to blend the makeup more seamlessly, for example, when makeup products are layered (e.g., applying concealer/blush over foundation). In some implementations, after 1006, control circuitry proceeds to 1010 (and/or 1008 and/or 1012). At 1010, control circuitry identifies multi-finger gestures (e.g., ring finger versus index plus middle combination). In some embodiments, after 1006, control circuitry proceeds to 1012 and checks the orientation/position of non-contact fingers to infer intended technique. After 1008, 1010, and/or 1012, control circuitry may proceed to 1014. In some implementations, at 1014, control circuitry maps a recognized gesture or multi-finger configuration to corresponding virtual tool (e.g., “large brush,” “spot coverage,” “pinching”). For example, many makeup artists prefer using the ring finger for undereye concealer because it naturally applies the least pressure, while the index or middle finger may be used for more robust blending of foundation on the cheeks.

By analyzing which fingers are in contact, as well as the orientation and relative positioning of the non-contact fingers, control circuitry may infer a user's intended technique. Such aspects allow specific simulations of various “finger tools,” such as using two fingertips in tandem to pat concealer in place or employing a “pinching” motion for targeted contour blending. Control circuitry may use additional computer vision heuristics or machine learning models for classifying multi-finger interactions. In some embodiments, control circuitry may represent each finger (or finger combination) as a different virtual makeup tool. For example, index and middle finger together may be used to mimic a two-finger blending sponge, a pinky finger for precise spot coverage, or the flat surface of three fingers to replicate a wide brush stroke. By detecting these configurations in real time, control circuitry may automatically switch between different virtual tool modes and update the rendered makeup effects accordingly. For instance, a three-finger contact may activate a “large brush” mode for broad strokes of powder, while a single fingertip with low force may signify a “detail brush” mode for subtle highlights or targeted applications, thus extending the realism and flexibility of virtual makeup systems.

At 1016, control circuitry may determine whether the user is rubbing a delicate area such as the undereye. If control circuitry determines that the user is not rubbing a delicate area, control circuitry may proceed to 1018 and continue with normal application. If control circuitry determines that the user is rubbing a delicate area, control circuitry may proceed to 1020 and warn the user or adapt to a suitable patting motion without smudging underlying products. For delicate areas like undereyes, control circuitry may advise the ring fingers to the users to apply makeup with least pressure. In some embodiments, at 1022, control circuitry blends or applies makeup effect in real time. In some implementations, at 1024, control circuitry renders an updated face with PBR shading and dynamic mesh resolution (e.g., close-up versus far-away view). In some embodiments, control circuitry may simultaneously perform any suitable combination of steps discussed in FIG. 8 and any suitable combination of steps discussed in FIG. 10 in parallel or in sequence. As a non-limiting example, multiple branches (e.g., 1008, 1010, 1012; 802, 812, 820; 836, 840, 846; etc.) may be performed in parallel or sequence.

The processes discussed above are intended to be illustrative and not limiting. One skilled in the art would appreciate that the steps of the processes discussed herein may be omitted, modified, combined and/or rearranged, and any additional steps may be performed without departing from the scope of the invention. More generally, the above disclosure is meant to be illustrative and not limiting. Only the claims that follow are meant to set bounds as to what the present invention includes. Furthermore, it should be noted that the features and limitations described in any one embodiment may be applied to any other embodiment herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods.

1. A method comprising:
obtaining a video comprising a user;
determining, based at least in part on the video, a portion of a face of the user with which a finger of the user is in contact;
determining, based at least in part on sensor data received from one or more sensors of a device in contact with the user, a force being applied by the finger to the portion of the face of the user; and
based at least in part on the determined force, applying an extended reality (XR) effect to a portion of the video comprising the portion of the face of the user.

2. The method of claim 1, wherein determining the force being applied by the finger to the portion of the face of the user is further based at least in part on detecting deformations of at least one of the face of the user or the finger of the user.

3. The method of claim 1, wherein determining the force being applied by the finger to the portion of the face of the user is further based at least in part on electromyography (EMG) data of the user received from at least one EMG sensor of the device in contact with the user.

4. The method of claim 1, further comprising providing haptic feedback, via one or more actuators of the device in contact with the user, based at least in part on the determined force.

5. The method of claim 4, further comprising receiving a selection of a cosmetic tool for the finger of the user to emulate, wherein the haptic feedback simulates a sensation that would be experienced by the selected cosmetic tool.

6. The method of claim 1, further comprising:
generating a three-dimensional (3D) model of the face of the user using depth data and red, green, and blue (RGB) data; and
generating a 3D model of the finger of the user using the depth data and the RGB data.

7. The method of claim 6, wherein applying the XR effect is based at least in part on the 3D model of the face and the 3D model of the finger.

8. The method of claim 6, wherein determining the portion of the face of the user with which the finger of the user is in contact comprises:
computing a minimal distance between a fingertip mesh of the 3D model of the finger and a face mesh of the 3D model of the face;
determining whether the minimal distance is below a threshold distance; and
based at least in part on determining that the minimal distance is below the threshold distance, determining that the finger of the user is in contact with the face of the user.

9. The method of claim 1, wherein the XR effect comprises a visual effect.

10. The method of claim 1, wherein the XR effect comprises haptic feedback.

11. The method of claim 1, wherein applying the XR effect to the portion of the video comprising the portion of the face of the user further comprises:
identifying a virtual makeup container in proximity of the user;
detecting, based at least in part on the video, a gesture made by the user to pick up an amount of virtual makeup from the virtual makeup container; and
applying the XR effect based on the amount of picked-up virtual makeup from the virtual makeup container.

12. A system comprising:
input/output circuitry configured to:
obtain a video comprising a user;
control circuitry configured to:
determine, based at least in part on the video, a portion of a face of the user with which a finger of the user is in contact;
determine, based at least in part on sensor data received from one or more sensors of a device in contact with the user, a force being applied by the finger to the portion of the face of the user; and
based at least in part on the determined force, apply an extended reality (XR) effect to a portion of the video comprising the portion of the face of the user.

13. The system of claim 12, wherein the control circuitry is further configured to determine the force being applied by the finger to the portion of the face of the user based at least in part on detecting deformations of at least one of the face of the user or the finger of the user.

14. The system of claim 12, wherein the control circuitry is further configured to determine the force being applied by the finger to the portion of the face of the user based at least in part on electromyography (EMG) data of the user received from at least one EMG sensor of the device in contact with the user.

15. The system of claim 12, wherein the control circuitry is further configured to provide haptic feedback, via one or more actuators of the device in contact with the user, based at least in part on the determined force.

16. The system of claim 15, wherein the control circuitry is further configured to receive a selection of a cosmetic tool for the finger of the user to emulate, wherein the haptic feedback simulates a sensation that would be experienced by the selected cosmetic tool.

17. The system of claim 12, wherein the control circuitry is further configured to:
generate a three-dimensional (3D) model of the face of the user using depth data and red, green, and blue (RGB) data; and
generate a 3D model of the finger of the user using the depth data and the RGB data.

18. The system of claim 17, wherein the control circuitry is further configured to apply the XR effect is based at least in part on the 3D model of the face and the 3D model of the finger.

19. The system of claim 17, wherein the control circuitry is further configured to determine the portion of the face of the user with which the finger of the user is in contact by:
computing a minimal distance between a fingertip mesh of the 3D model of the finger and a face mesh of the 3D model of the face;
determining whether the minimal distance is below a threshold distance; and
based at least in part on determining that the minimal distance is below the threshold distance, determining that the finger of the user is in contact with the face of the user.

20. The system of claim 12, wherein the XR effect comprises a visual effect.

21-55. (canceled)
